(19) United States
(12) Patent Application Publication
(10) Pub. No.: US 2018/0223746 A1
(43) Pub. Date: Aug. 9, 2018

(54) LOCOMOTIVES

(71) Applicants: Thomas Mack, (US); Peter Paul Roosen, Wellington (CA); Robert Nigel Horsley, Vancouver (CA); VeRail Technologies, Inc., Reno, NV (US)

(72) Inventors: Thomas Mack, Cincinnati, OH (US); Peter Paul Roosen, Wellington (CA); Robert Nigel Horsley, Vancouver (CA)

(21) Appl. No.: 15/939,684

(22) Filed: Mar. 29, 2018

Related U.S. Application Data
(63) Continuation of application No. PCT/CA2016/051134, filed on Sep. 29, 2016.
(60) Provisional application No. 62/234,576, filed on Sep. 29, 2015.

(51) Int. Cl. F02D 25/04; F02B 43/02; F02B 63/04; F02B 73/00; F02D 29/06; F02D 35/00; B61C 7/04; B61C 17/12; G06Q 10/06

(52) U.S. Cl. CPC F02D 25/04; F02B 43/02; F02B 63/042; F02B 73/00; F02D 29/06; F02D 35/0015; G01C 17/00; B61C 17/12; G06Q 10/06313; F02D 2200/06; F02D 2200/025; Y10S 903/93; B61C 7/04

(57) ABSTRACT

Locomotives comprising a chassis configured for receiving various modules such as, for example, fuel storage modules and/or power modules. By employing a selected combination of fuel storage modules and power modules, a locomotive may be constructed to employ any of one or more types of fuel, such as liquid fuels and gaseous fuels. Batteries may be employed to maximize energy use. Multiple locomotives may function together as a ‘consist’ having differing types of engines and using different types of fuel. A control system may be employed to optimize use of the engines by prioritizing factors such as cost, fuel efficiency, noise reduction, emissions reduction, etc.

### CROSS-REFERENCE TO RELATED APPLICATIONS

This is a continuation of International Application No. PCT/CA2016/051134, filed Sep. 29, 2016, which claims the benefit of U.S. Provisional Application No. 62/234,576, filed Sep. 29, 2015, both of which applications are hereby incorporated herein by reference for all purposes.

### TECHNICAL FIELD

This invention relates to railroads and, in particular, to railroad locomotives. Embodiments provide modular locomotive systems comprising a range of power sources as well as control systems for prime movers such as locomotives. Such control systems may dynamically coordinate the operation of power sources such as engines that may use fuel of a plurality of fuel types in order to achieve operational goals.

### BACKGROUND

Railways have utilized many fuel sources for the locomotives used to move railway cars in rail yards and local areas and trains over greater distances since their advent in the early 1800s. The first major fuels were solid fuels including wood and coal that were burned in steam engines. The burning mixture of fuel and air boils water in such steam engines to generate steam which in turn is converted to mechanical energy used to propel the locomotive and pull one or more accompanying railway cars. Generally, there is insufficient space on board a steam locomotive to carry enough fuel and water to maintain sufficient range. This necessitated the development and inclusion of special railway cars that carried the requisite quantities of fuel and water. These special purpose railway cars that were and are often semi-permanently coupled to the locomotives became known as “fuel tender cars” or simply “tenders” or a “tender” in the case of an individual one.

Gradually, liquid fuels such as heavy fuel oil also came into use. Oftentimes, steam locomotives that burned a solid fuel such as coal were converted to burn liquid fuel oils, and, as such, liquid fuel became more readily available and economically attractive.

Another type of locomotive is the electric locomotive that converts electrical energy from an external source such as an overhead electric catenary or electrified third rail into mechanical tractive effort. This type of locomotive has been in widespread use for many years in spite of its inability to operate without an active external electrical energy supply. However, largely due to the relatively high costs associated with constructing and maintaining the normally complex external electrical energy supply, this type of locomotive is usually employed with relatively small trains where rail passenger or freight traffic densities are high such as in major railway traffic corridors between relatively close large cities or where the distances are fairly short such as in commuter railway systems. Where the distances become much greater, the trains heavier and/or the traffic densities are relatively low, the preference has been to use locomotives that carry their own fuel directly on board the locomotive or, where necessary, using an associated tender.

Fuel tenders, however, are considered a great inconvenience and are generally not desired. There are relatively few currently in service on U.S. railroads in comparison to the number of locomotives in existence (perhaps less than a dozen tenders relative to well over 20,000 locomotives). Tenders can be costly in terms of both their construction and maintenance costs. Tenders also need to be managed both in the fleet and as part of a locomotive consist. Often, specific tenders are closely associated with specific locomotives. Whether closely associated with particular locomotives or as part of a pool, the management of fuel tenders is an undesirable burden for most if not all railways trying to minimize motive power costs.

A further problem is that costly fuel tenders displace revenue cars on a train. Thus while a tender extends the range between refueling, it has a major drawback in that it requires a portion of locomotive power to be used to pull it. As a direct result, this power is no longer available to pull revenue freight or paying passengers on the train.

Additionally, the additional tender(s) require corresponding reductions in the number of revenue cars to maintain the same overall train length to fit on length-limited sidings. This has become especially important in recent years as caboose eliminations and improving locomotive, railway car, track and operating technologies are enabling the addition of more revenue cars per train.

Locomotives need to be heavy to provide sufficient tractive effort. Locomotives used for long haul (line haul) service in the U.S. are normally engineered to provide loads of approximately 65,000 to 70,000 pounds on each axle for optimum traction. Greater weights can result in the locomotives exceeding the capacity of the track and structures. It is also important to not exceed the maximum allowable stresses between the wheel and rail, above which the steel wheel and rail components begin to deform plastically. Lesser weights can result in lower tractive effort per locomotive which is also not desirable. There is therefore a precise target weight per locomotive relative to the number of axles thereunder to keep axle loadings to within the desired engineered ranges.

The modern diesel-electric locomotive has become the most commonly available and used type of railway locomotive worldwide. Diesel engines commonly used in modern diesel-electric locomotives typically operate under load at a speed of approximately 900-1100 RPM. Some locomotives having smaller engines, commonly referred to as “multi-genset” locomotives, typically operate under load at approximately 1800 RPM but not in excess of 2100 RPM.

Electric locomotives that draw electrical energy from an overhead catenary or third rail are the second most commonly available type of locomotive. Diesel-electric and straight electric locomotives differ mainly in that the diesel-electric locomotive has one or more diesel engines (compression-ignition internal combustion reciprocating piston engine) onboard, whereas the electric locomotive does not have an onboard engine since the electrical energy is generated at some other location and delivered to the locomotive through the catenary, third rail or other means.

Typically, both diesel-electric and straight electric locomotives use individual electric traction motors to turn each respective locomotive propulsion axle to propel the train. The train itself may consist of one or more locomotives connected to one or more associated cars through a series of coupling mechanisms or couplers. When a group of locomotives is used to pull a train, this group of locomotives is often referred to as a “locomotive consist” or simply a “consist”. A train can have one or more locomotive consists located in different parts of the train.

Straight electric operation for heavy freight service has important limitations. The power requirements are enormous, much greater than for passenger rail service. A 5,000 to 10,000 horsepower passenger train operating at relatively high speeds, often in excess of 70 miles per hour, has a much lower power supply capacity requirement than a 15,000 to 45,000 horsepower heavy drag freight train moving with full power at usually much lower speeds rarely exceeding 70 miles per hour. High speed passenger trains are usually spaced at least a few miles apart so the electrical demands are better distributed along the railway as compared to the heavy freight trains that have the locomotives each drawing their enormous quantities of electrical energy from the external electrical system within the length of the train which is usually little more than a mile long.

The cost of installing and maintaining the required infrastructure of power plants, sub-stations, electrical distribution and overhead catenary or third rail in addition to the locomotives themselves is enormous relative to diesel-electric locomotive operation. Furthermore, there is no limit as to how many diesel-electric locomotives can operate within a given section of railway since there is no need to space diesel-electric locomotives or trains apart to avoid exceeding electrical power supply limitations.

Electric operation, however, requires trains and locomotives to be spaced such that the collective load does not exceed the electrical system limits at any point along the railway. The power requirements of freight traffic may very well require the installation of additional new multi-megawatt power plants to support the rail traffic where a railroad is considering converting from diesel-electric to electric locomotive operation. Procuring permits and installing additional power plants is normally very difficult, slow and expensive, particularly in urban areas where siting for the requisite power plants, sub-stations and high voltage electrical power lines is especially challenging.

Some locomotives employ a mix of powered and unpowered axles. These locomotives may use the unpowered axles to better distribute weight, or it may be that some axles are left unpowered in order to reduce cost. Some train sets use powered axles under the train cars in addition to the powered locomotives axles.

One particular type of locomotive is known as a “slug”. A slug is a locomotive that has powered axles but no onboard engine. It receives its electric power from a “mother” locomotive. The mother provides the slug with electric power via high-voltage cables connected between the mother and slug. In the cases where slugs are employed, one or more of the axles under the slug are powered. The terms “master” and “slave” have also been used instead of the respective “mother” and “slug” in some instances to describe this type of locomotive pairing. Some slugs have been referred to as “mates”, but still require a powered locomotive to supply the electricity.

There is a growing tendency to power axles located under tenders. This is quite feasible because the electrical energy is easily delivered across the couplers from one unit to the next through electrical cables. For example, U.S. Pat. No. 6,408,766 issued to McLaughlin et al. Jun. 25, 2002 titled Auxiliary drive, full service locomotive tender, discloses an auxiliary tender car for locomotives which stores fuel and delivers the fuel to the locomotives while underway. The tender also includes traction motor drive axles where the motors of the tender car are powered by the attending locomotive(s). The tender may also be capable of dynamic braking. The tender operates much like a road slug, except that it carries fuel, displacing some of the ballast required for a slug to generate traction. It should also be noted that safety and construction regulations in countries such as the United States differentiate between a slug, which is considered a locomotive, and tenders, which are considered freight cars when they are not coupled in a locomotive consist. A tender must meet certain federal regulations which a locomotive does not have to meet, and vice versa.

Most locomotives are equipped with a functional operator's cab. The cabs on modern locomotives protect the operators from outside weather, noise and fumes. In a functional operator's cab, the operator has available at least a place to sit, windows, throttle controls, braking controls, locomotive status displays, bell and horn controls. Cabs on U.S. locomotives are presently required to meet specific crashworthiness standards as set out by the AAR and FRA in various regulations.

A cabless locomotive may not have an operator's cab or it may have had a cab rendered unusable by blacking out windows, locking doors, removing seats and/or other means. These cabless locomotives are not designed or intended to be operated as a lead locomotive position at the head end of a train and therefore are always in use with at least one other locomotive that can operate from the leading position.

In the past, a primary motivator behind improvements in locomotives and related technology has been for better economics and performance This was exemplified by a persistent push to create more powerful locomotives in order to be able to do more work with less equipment, while doing so more efficiently. Fuel economy as it relates to work has been improving quite remarkably as the extremely low thermal efficiency steam locomotives were replaced by electric and diesel-electric locomotives during the last half century. However this is changing as tightening emissions requirements influence traditional fuel economy and performance in favor of cleaner diesel engines that may not be as fuel efficient.

A major concern of railroad operators is that current locomotive models are becoming less fuel efficient than previous models. They are also becoming much more expensive to maintain. Locomotive diesel engines may now require exhaust gas recirculation (EGR) or expensive exhaust after-treatment systems such as selective catalytic reduction (SCR) and diesel particulate filtration (DPF) systems to meet emissions standards. The use of these after-treatment systems requires the addition of an economically burdensome new supply chain of consumable chemicals, such as liquid urea solutions (also known as DEF or Diesel Emissions Fluid) to be frequently loaded onto the locomotive along with fuel and the traditional other consumables such as traction sand. Emission standards for railway locomotives may apply to newly manufactured as well as remanufactured locomotives and locomotive engines.

Trends appear to be transitioning from having fewer and more powerful locomotives (e.g. approximately 6,000 horsepower) toward larger numbers of somewhat standardized locomotives (e.g. 4,300-4,400 horsepower). For instance, modern multiple unit and distributed power unit systems allow several locomotives grouped in various places on a given train to operate without the need to have multiple persons aboard the train to manage the various locomotives located throughout the train.

Such groupings are commonly referred to as locomotive, motive power or power “consists” or simply as a “consist” in the case of an individual grouping of more than one locomotive. Those located at the head or front end of the train are referred to as the “head end” locomotive power or consist, with the foremost locomotive being called the “lead locomotive” or “lead unit” and the other locomotives in the locomotive head end consist being referred to as “trailing” locomotive(s) or unit(s). Similarly, one or more locomotives can be placed mid-train, generally someplace between the head and tail or back ends of the train, usually about half to two-thirds of the way back from the head end. Placing a locomotive or locomotive consist at the back end of a train is also done frequently on U.S. railroads.

In some extraordinarily long and heavy trains, there can be as many as a dozen and sometimes more locomotives located throughout the train which can be well over a mile long, having a two to four locomotive consist at the head end, one to four more locomotives mid-train and one to four more locomotives at the tail end. Such a train can weigh over 15,000 tons. Pulling such weight up steep grades at high enough speeds requires approximately two to three horsepower per ton. Thus, such trains may need 45,000 horsepower or more. Typical bulk commodity unit or mixed freight 8,000 to 12,000 ton trains that are allowed to move at lower speeds while not anticipating steep grades can operate with much lower horsepower. These trains can operate with as little as one-half to one horsepower per ton. High speed intermodal trains climbing through mountain ranges at relatively high speeds might be dispatched with enough locomotives to provide three or more horsepower per ton.

It is not as common to find single locomotives rather than consists occupying the head end and mid-train positions on large freight trains since the size of the consist is usually determined by the maximum amount of force that can be safely transmitted through the drawbars, couplers and draft gear. It is quite common to see a two-locomotive consist at the front of the train, with a single distributed power unit (DPU) locomotive pushing on the rear of the train.

A notable exception can often be found in passenger trains which tend to be much lighter and shorter than the long and heavy freight trains that are typical of U.S. railways. It is common to find a single locomotive at each end of a passenger train such that the train can be operated in either direction without needing to reposition locomotives on the train or turn the train around.

Within a single locomotive, new technologies have enabled the use of more than one engine-generator system to be used in tandem. These are commonly referred to as “multi-genset” locomotives. This was mainly done for efficiency improvements and to meet new low emissions requirements. Other motivators include having the ability to have the trains continue to their destination notwithstanding the failure of one or more of the locomotives or, in the case of the multi-genset locomotives, the failure of one or more of the systems thereon.

Typically, where gaseous fuel has been employed as a locomotive fuel, the engines running on gaseous fuel are converted from traditional diesel engines. For example, gaseous fuel may be employed in combination with liquid fuel (e.g. diesel) in a dual-fuel engine or gaseous fuel may be employed on its own in a diesel engine more substantially converted to operate using gaseous fuel exclusively. Such converted engines are inherently less optimized for use with gaseous fuels than an engine strictly designed to operate using gaseous fuel.

There are also other gaseous fuels technologies not dependent on diesel engines that have been proven to be technically feasible for railroad operation, but not commercially viable on an industry-wide scale. For example, U.S. Pat. No. 5,129,328 issued to Donnelly Jul. 14, 1992 titled “Gas turbine locomotive fueled by compressed natural gas”, discloses a gas turbine engine locomotive fueled by compressed natural gas (CNG).

Recent changes in the geopolitics of natural gas relative to oil, enabled by technological changes including the now widespread practice of combining hydraulic fracturing and horizontal drilling that are unlocking vast quantities of domestic natural gas, are making natural gas a fuel of great interest to railways. Combining that with the fact that natural gas emissions are generally much lower and potentially less harmful than diesel emissions, this has created a climate in which natural gas has become a strong contender for displacing diesel fuel, perhaps similarly to the way in which diesel replaced coal many years earlier.

The form of natural gas currently being given the greatest consideration for long haul trains is liquefied natural gas (LNG) used to supply gaseous natural gas (GNG) to a dual fuel diesel engine where the diesel engine can be operated wholly on diesel fuel as a fall back option. Compressed natural gas (CNG) has been found to be better suited for local and yard service although LNG options remain interesting for these services in spite of the problem of needing to vent the LNG as it picks up heat energy from its surroundings and starts to vaporize if it is not being constantly consumed. Although CNG would be preferred, there has not been the ability to carry enough CNG to provide sufficient range between fueling stops and long enough fueling intervals for long haul freight service. Similarly, LNG for long haul service has required the use of fuel tenders.

Both LNG and CNG infrastructure has been expanding on a large scale throughout North America and the world at an increasing rate in recent years as the supply has burgeoned. Globally the potential natural gas trapped in shale rock is, by some estimates, set to provide abundant, cheap natural gas well into the next century, with the U.S. remaining a major participant for the foreseeable future. There is a general desire to capitalize on the cost and availability of natural gas with locomotives capable of using natural gas while meeting the stringent emissions standards.

There is a general desire to have locomotives that operate on natural gas and that are able to revert back to full diesel operation while maintaining the traditional balance of excellent performance, reliability and efficiency associated with diesel-electric locomotives of recent decades.

The foregoing examples of the related art and limitations related thereto are intended to be illustrative and not exclusive. Other limitations of the related art will become apparent to those of skill in the art upon a reading of the specification and a study of the drawings.

### SUMMARY

The invention has a number of different aspects which may be employed individually or in combination. These aspects include, without limitation:
modular locomotives;
high-speed engine locomotives;
multi-fuel locomotives having multiple engines each optimized for a specific fuel;
modules suitable for use in modular locomotives;
fuel systems for locomotives;
control systems for locomotives and other power generation systems;
control systems for multi-fuel locomotives;
control systems for multi-fuel locomotive consists;
modular locomotive consists;
multi-fuel locomotive consists;
methods for reducing locomotive and/or train emissions;
methods for reducing locomotive and/or train fuel consumption;
methods for reducing locomotive and/or train costs;
methods for complying with locomotive and/or train regulations (e.g. emissions regulations);
methods for starting locomotive engines;
systems for starting locomotive engines;
methods for making modular locomotives and/or trains;
methods for controlling locomotive consists;
methods for optimizing multi-engine type locomotives and/or consists;
trains comprising any or all or any combination of the above listed aspects.

One example aspect of the invention provides a locomotive having first and second power modules. The first power module includes a first engine optimized to run on a first fuel and a first generator coupled to be driven by the first engine to generate electrical power. The second power module includes a second engine optimized to run on a second fuel and a second generator coupled to be driven by the second engine to generate electrical power. The first fuel is supplied to the first power module from a first fuel module. The second fuel is supplied to the second power module from a second fuel module. Electricity from the first and second generators is provided to an electrical bus which in turn provides power to a drive system of the locomotive. A control system is connected to the first power module, the second power module, the first fuel module, the second fuel module and the electrical bus. The control system is configured to individually control a first power output level of the first power module and a second power output level of the second power module according to a total power requirement of the drive system of the locomotive.

In some embodiments, the control system is configured to individually select a power output level of the first power module and a power output level of the second power module based at least in part on a comparison of one or more characteristics of the first fuel to one or more corresponding characteristics of the second fuel.

The control system may be configured to store first pollution emission information comprising first pollution emission values associated with the running the first engine on the first fuel at different first power output levels and second pollution emission information comprising second pollution emission values associated with running the second engine on the second fuel at different second power output values. The control system may be configured to bias the first power output level and the second power output level to minimize both of the first pollution emission values and the second pollution emission values while providing a cumulative power output from the first and second engines according to the total power requirement of the drive system for the locomotive.

In some embodiments, the first power module and the second power module each comprise one or more emissions sensors operative to detect one or more emissions of the first power module and the second module. The control system may be connected to receive outputs from the one or more emissions sensors of the first power module and the second power module. The first pollution emission information and the second pollution emission information may be updated in real-time based on the outputs from the one or more emissions sensors of the first power module and the second power module.

In some embodiments, the first fuel module comprises a first fuel level sensor connected to the control system and the second fuel module comprises a second fuel level sensor connected to the control system. The one or more characteristics of the first fuel may comprise a first fuel level of the first fuel as determined using the first fuel level sensor and the corresponding one or more characteristics of the second fuel may comprise a second fuel level of the second fuel as determined using the second fuel sensor. The control system is configured to bias the power output level of the first engine to be higher than the power output level of the second engine when the first fuel level is higher than the second fuel level.

In some embodiments, the first power module comprises a first ambient noise sensor connected to the control system and the second power module comprises a second ambient noise sensor connected to the control system. The one or more characteristics of the first fuel may be a first ambient noise emission associated with the running the first engine on the first fuel determined using the first ambient noise sensor and the corresponding one or more characteristics of the second fuel may be a second ambient noise emission associated with running the second engine on the second fuel determined using the second ambient noise sensor. The control system may be configured to bias a power output level of the first engine to be higher than the power output level of the second engine when a combined ambient noise of the first engine and the second engine is higher than an ambient noise threshold and the first ambient noise emission is lower than the second ambient noise emission.

In some embodiments, the control system is configured to store first cost information comprising a first cost associated with running the first engine on the first fuel and second cost information comprising a second cost associated with running the second engine on the second fuel. The one or more characteristics of the first fuel may be the first cost information and the corresponding one or more characteristics of the second fuel may be the second cost information. The control system may be configured to bias the power output level of the first engine to be higher than the power output level of the second engine when the first cost information is lower than the second cost information. The first cost associated with the running the first engine may be a cost of the first fuel in the first fuel module, a cost to refill the first fuel module and a cost to operate the first engine per unit of distance, and the second cost associated with the running the second engine may be a cost of the second fuel in the second fuel module, a cost to refill the second fuel module and a cost to operate the second engine per unit of distance.

In some embodiments, the control system is configured to monitor and record a first fuel efficiency of the first engine at different first power output levels and monitor and record a second fuel efficiency of the second engine at different second power output levels. The one or more characteristics of the first fuel may be the first fuel efficiency of the first engine at different first power output levels and the corresponding one or more characteristics of the second fuel may be the second fuel efficiency of the second engine at different second power output levels. The first power output level and second power output level may be biased based on an optimization of the first fuel efficiency of the first engine at different first power output levels and the second fuel efficiency of the second engine at different second power output levels for the total power requirement of the drive system.

In some embodiments, the locomotive comprises a navigation system connected to the control system. The control system may include a database of fueling stations for the first fuel and fueling stations for the second fuel. The one or more characteristics of the first fuel may be a distance on a route being traveled by the locomotive to a next fueling station for the first fuel determined using the navigation system and the database of fueling stations for the first fuel and the corresponding one or more characteristics of the second fuel may be a distance to a next fueling station for the second fuel determined using the satellite navigation system and the database of fueling stations for the second fuel. The control system may configured to bias the power output level of the first engine to be higher than the power output level of the second engine to conserve the second fuel when the distance to the next fueling station for the first fuel is shorter than the distance to the next fueling station for the second fuel.

In some embodiments, the locomotive has a battery connected to the electrical bus and configured to store surplus power provided to the electrical bus. The power level of the first power module and the power level of the second power module may be lowered after a charge level of the battery is greater than a threshold charge level.

In some embodiments, the control system is configured to shut off the first power module and the second power module when the battery has a sufficient charge level to maintain a power output equal to or greater than the total power requirement of the drive system for the locomotive for a period sufficient to offset restarting the first power module and the second power module.

In some embodiments, the control system is configured to bias the power level of the first power module and the power level of the second power module based at least in part on a current operating temperature of the first engine.

In some embodiments, the first power module comprises a first temperature sensor and the control system is configured to monitor and record a fuel efficiency of the first power module with respect to temperature recorded by the first temperature sensor. The control system may be configured to bias the first power output based at least upon an optimized operating temperature of the first power module determined based on the fuel efficiency of the first power module with respect to temperature recorded by the first temperature sensor.

In some embodiments, the first engine has a maximum operating speed greater than 2500 RPM. In some embodiments, the first and second engines each have a maximum operating speed greater than 2500 RPM. In some embodiments, the first and second fuels are gaseous fuels.

In some embodiments, the locomotive comprises a fuel cell module and the control system is configured to shut off the first power module and the second power module when the total power requirement of the drive system is projected to be less than a maximum available power output of the fuel cell for the locomotive for a period sufficient to offset restarting the first power module and the second power module.

In some embodiments, the first power module and first fuel module are replaceable with an alternative power module and an alternative fuel module by disconnecting one or more attachment points and interconnectors of the first power module and the first fuel module and connecting one or more attachment points and interconnectors of the alternative power module and the alternative fuel module. The control system may be configured to identify the alternative power module and the alternative fuel module and select the second power output level and an a power output level of the alternative power module based at least in part on one or more characteristics of the second fuel relative to one or more corresponding characteristics of the fuel of the alternative fuel module.

In some embodiments, in addition to the first and second power modules and first and second fuel modules, the locomotive comprises a diesel engine and a corresponding generator coupled to be driven by the diesel engine to generate fourth electrical power for the electrical bus, the diesel engine having a maximum operating speed below 2500 RPM. A diesel fuel container may be present for supplying diesel fuel to the diesel engine and the control system may be configured to have a diesel mode in which a power deficiency of the first power module and second power module is supplied by the diesel engine.

In some embodiments, the control system is connected to one or more of the first power module, the second power module, the first fuel module, the second fuel module and the electrical bus by a wireless connection.

In some embodiments, the locomotive comprises a quantum compass or atomic inertial guidance system connected to the control system and the control system is configured to individually control the first power output level of the first power module and the second power output level of the second power module according to the total power requirement of the drive system of the locomotive based on a location determined by the quantum compass or atomic inertial guidance system.

Another example aspect of the invention provides a locomotive having one or more power modules, each power module comprising one or more high speed engines operable using gaseous fuel at over 2500 RPM and one or more corresponding high speed generators connected to the one or more high speed engines. The locomotive may also comprise one or more fuel modules, each fuel module storing a gaseous fuel and connected to provide the gaseous fuel to one or more of the one or more power modules. An electrical bus may be provided for receiving power from each of the one or more power modules and for delivering power to drive the locomotive and a control system may be configured to coordinate power output levels from each of the one or more power modules to the electrical bus.

In some embodiments, there is a plurality of power modules and a first subset of the plurality of power modules is optimized to run on a first fuel and a second subset of the plurality of power modules is optimized to run on a second fuel, different from the first fuel.

In some embodiments, the control system is configured to choose a power level of one or more of the power modules of the first subset of power modules and a power level of one or more of the power modules of the second subset of power modules based at least in part on one or more characteristics of the first fuel relative to one or more corresponding characteristics of the second fuel.

In some embodiments, the locomotive further comprises a diesel engine having a maximum operating speed below 2500 RPM and a diesel fuel container for supplying diesel fuel to the diesel engine in addition to the plurality of power modules.

Another example aspect of the invention provides a method for refurbishing a pre-existing locomotive having one or more diesel engines, each of the one or more diesel engines having a maximum operating speed of less than 2500 RPM. The method may first comprise removing at least one of the one or more diesel engines and removing one or more generators associated with the at least one diesel engine. Next, the method may comprise installing a plurality of high speed power modules on the locomotive, installing one or more fuel modules on the locomotive and installing a control system configured to individually control a power output level of the plurality of power modules according to a total power requirement of a drive system for the locomotive. The high speed power modules may each comprise a high speed engine having a maximum operating speed greater than 2500 RPM and a high speed generator connected to the high speed engine.

The cumulative power of the plurality of high speed power modules may be at least equal to the cumulative power of the at least one diesel engine. In some embodiment, one or more fuel tanks associated with the at least one diesel engine is removed.

In some embodiments, the cumulative space required for the plurality of high speed power modules and the one or more fuel modules is less than the space required for the at least one diesel engine and the one or more fuel tanks associated with the at least one diesel engine. In some embodiments, the volume of fuel storage of the one or more fuel modules is greater than the volume of fuel storage of the one or more fuel tanks associated with the at least one diesel engine.

In some embodiments, the method comprise installing a fuel cell power module on the locomotive within the space required for the at least one diesel engine and the one or more fuel tanks associated with the at least one diesel engine. In some embodiments, the method further comprises installing a battery module on the locomotive within the space required for the at least one diesel engine and the one or more fuel tanks associated with the at least one diesel engine.

In some embodiments, a first subset of the plurality of high speed power modules is optimized to run on a first fuel and a second subset of the plurality of high speed power modules is optimized to run on a second fuel. In some embodiments, one or more of the one or more power modules run on a gaseous fuel.

In some embodiments, at least one remaining diesel engine having a maximum operating speed below 2500 RPM is left substantially unaltered on the locomotive and at least one remaining diesel fuel container for supplying diesel fuel to the at least one remaining diesel engine is also left on the locomotive.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced Figures of the drawings. The embodiments and Figures disclosed herein are intended to be illustrative rather than restrictive.

FIG. 1 is a schematic side elevation view of a locomotive chassis according to an example embodiment.

FIG. 2 is an example modular locomotive comprising power and fuel modules assembled on a chassis like that shown in FIG. 1.

FIG. 3 is a perspective view showing a module according to an example embodiment.

FIG. 4 is a perspective view showing an example fuel module.

FIG. 5 is a perspective view showing an example power module.

FIG. 6 is a perspective view showing an example battery module.

FIG. 7 is a perspective view showing an example generator module.

FIGS. 8 to 12 are schematic side elevation views showing various examples of modular locomotive constructions.

FIG. 13 is a block diagram showing an example control system.

FIGS. 14 to 16 are side views of trains according to example embodiments.

FIG. 17 is a bar graph representing the relative proportion of power supplied at each throttle notch by each power module according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention may be applied to provide modular locomotives. In some embodiments, a locomotive comprises a chassis configured for receiving various modules such as, for example, fuel storage modules and/or power modules. This modular construction facilitates rapid construction of locomotives having various configurations by combining standardized modules and mounting the modules to a rolling chassis. Some embodiments permit reconfiguration and/or rapid refurbishing of existing modular locomotives by replacing, adding, removing, and/or rearranging modules. In some embodiments modules of a given type are generally interchangeable (e.g. have common envelopes).

By employing a selected combination of fuel storage modules and power modules, a locomotive may be constructed to employ any of one or more types of fuel, such as, but not limited to: homogeneous fuels such as natural gas, ethane, propane or hydrogen, or mixtures of gaseous fuels, such as mixtures of methane or natural gas and hydrogen (also known as hythane) or mixtures of hydrogen, carbon monoxide and often carbon dioxide (also known as syngas). In particular embodiments, gaseous fuel engines are employed in place of or in addition to diesel locomotive engines. Gaseous fuel engines, and in particular, high-speed gaseous fuel engines may weigh considerably less than a compression ignition engine such as a diesel locomotive engine while producing similar output power.

A locomotive constructed using a combination of two or more different power modules may provide flexibility in the choice of fuel and in operation. The two or more different power modules may work in tandem as controlled by control systems described herein. Different fuels may be used at different times, individually or in combination, to allow the locomotive to operate in a way that is fuel efficient, less polluting, and/or more economical than would be possible with an equivalent power diesel engine. Different fuels may be used by different power modules simultaneously. For example, a locomotive may be run on hydrogen fuel provided by a first type of fuel storage module and consumed by a first type of power module to produce low CO₂ emissions. If there is a need for additional power, the locomotive may additionally be run on natural gas or a combination of natural gas and hydrogen fuel, the natural gas provided by a second type of fuel storage module and consumed by a second type of power module. This capability may be exploited to quickly and easily operate the locomotive to achieve a desired efficiency while meeting power output requirements, emissions requirements and/or the like. Different control strategies may be applied in different sections of a railroad in response to factors such as local regulations, geographical factors such as grade, airshed characteristics and/or operational factors such as desired speed, time/distance to next scheduled refueling, etc.

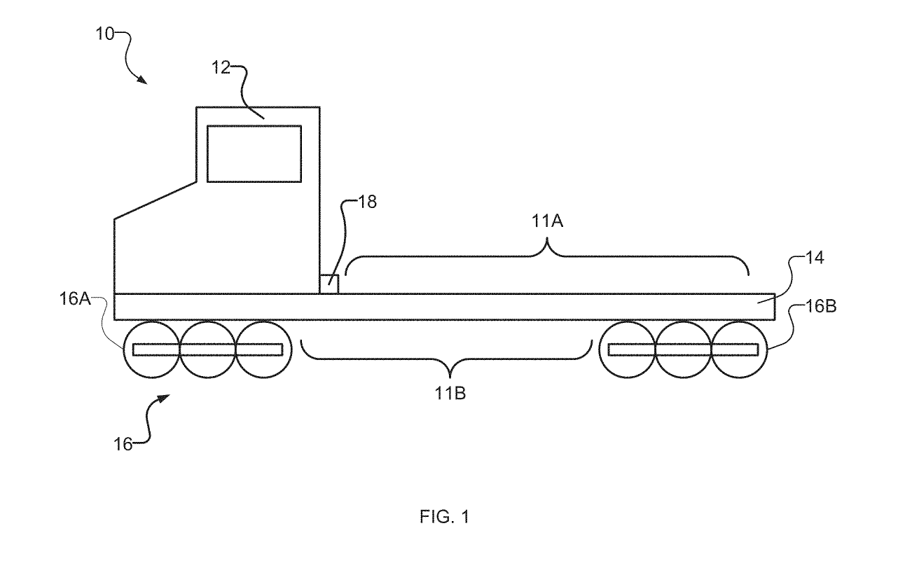

FIG. 1 depicts a chassis 10 according to an example embodiment. Chassis 10 comprises a cab 12 mounted to a locomotive frame 14 supported by a traction drive system 16. Traction drive system 16 and locomotive frame 14 may further comprise or support additional components such as trucks, wheels 16A, 16B, traction motors, brake rigging, suspension and related components that are not depicted or enumerated herein for the sake of convenience and brevity.

In some embodiments, chassis 10 may comprise components of a base locomotive such as, for example, an EMD Model SD70MAC, GP7/8/9/10, EMD SW1200, EMD SD9043MAC or equivalent having one or more of the fuel tank, engine-generator system and related equipment normally provided on these base locomotives removed or relocated.

It may be beneficial to base a modular locomotive on a pre-existing chassis as this decreases research and development costs while boosting confidence of potential first adopters that are familiar with the pre-existing chassis. Further, parts for such a chassis may be sourced through existing supply chains. Training may also be reduced as operators may already be familiar with many elements of the chassis. A suitable chassis may be newly fabricated or taken from an existing locomotive, for example, a locomotive that requires refurbishing.

In other embodiments, chassis 10 may comprise a purpose-built chassis comprising some or all of at least: a cab and its contents, a frame, trucks that provide traction, traction motors, wheelsets, brake rigging, suspension and related components.

Chassis 10 may comprise various spaces configured for receiving modules, such as power modules, fuel storage modules and the like. For example, chassis 10 may comprise a space 11A above locomotive frame 14 and a space 11B below frame 14, between wheelsets 16A, 16B. Modules of various kinds may be installed in spaces 11A and 11B.

Chassis 10 may additionally comprise various chassis interconnections 18 for receiving and connecting to modules. Interconnections 18 may comprise fuel line inputs and outputs, electrical inputs and outputs, control and monitoring connections, cooling fluid inputs and outputs and the like. Interconnections 18 may facilitate, for example, carrying power from a power module to traction drive system 16, or, for example, a control connection to cab 12 for allowing an operator to control or monitor the connected module.

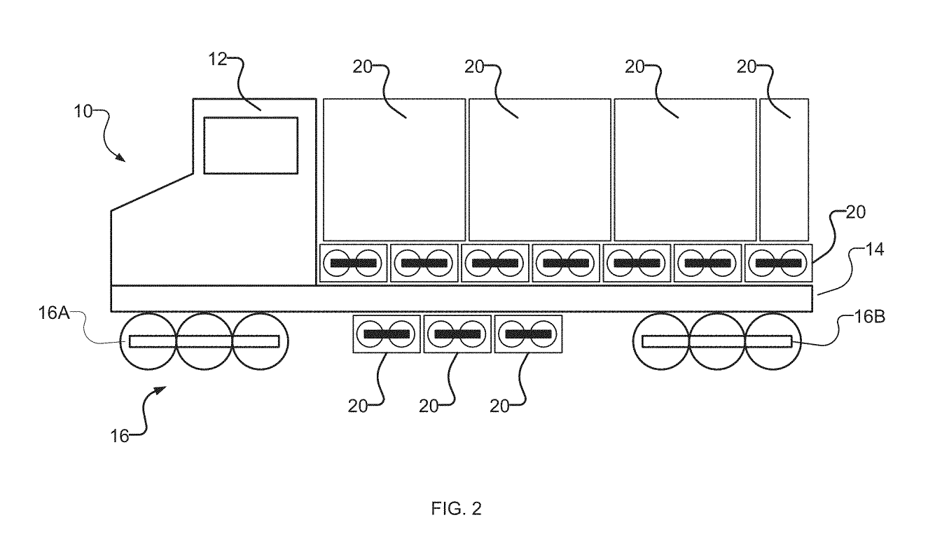

FIG. 2 depicts chassis 10 having a plurality of modules 20, installed thereon according to an example embodiment. Modules 20 may comprise fuel modules 22, power modules 24, generator modules 26, battery modules 28 and/or other modules. Modules 20 may be provided in various combinations and locations on chassis 10, depending on the desired properties of the locomotive and the interrelationships between modules 20, as described in more detail herein.

As can be seen from FIG. 2, modules 20 may be installed above and/or below locomotive frame 14. For example, fuel modules 22 may be installed under locomotive frame 14 in space 11B while additional fuel modules 22 and power modules 24 are installed above locomotive frame 14 in space 11A. This particular organization is not mandatory. Modules 20 may be organized above and/or below locomotive frame 14 as needed or desired.

FIG. 2 depicts modules 20 as being installed in contact with other adjacent modules 20. This is not mandatory. In some embodiments, it may be preferred to provide spacing between modules 20. For example, it may be beneficial to allow for ventilation between certain modules 20 to prevent overheating. In some embodiments, spacers (not depicted) may be provided between modules 20. Spacers may comprise heat shields, cooling units, vibration dampeners, or structural support for protecting modules 20.

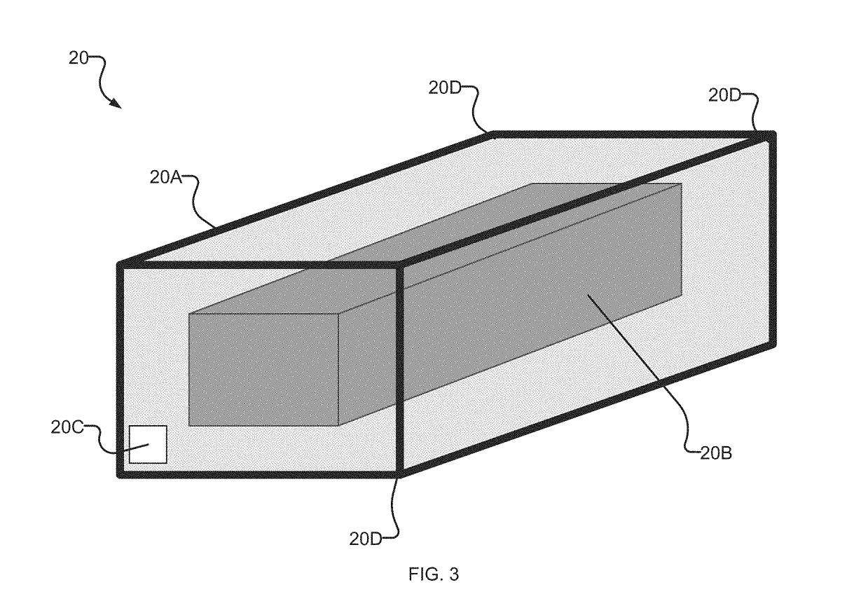

FIG. 3 depicts a module 20 according to an example embodiment. Module 20 may be, for example, a fuel module, a power module or a battery module. The module 20 of FIG. 3 comprises a frame 20A, one or more active components 20B and one or more interconnectors 20C. Active components 20B may be located within an envelope defined by frame 20A. The nature of active components 20B depends on the nature of the module 20. In different example modules 20 active components 20B may comprise one of more of:
an engine;
a generator;
a fuel cell;
an air compressor;
a fuel store;
electrical storage batteries;
an exhaust treatment unit;
fuel transfer systems such as pressure regulators, gasifiers, heat exchangers etc.

In some embodiments some or all modules 20 are structural. The structure of modules 20 may be applied to support other modules 20 (or other devices or components) and/or to reinforce frame 14. For example, a module 20 may be capable of supporting one or more additional modules 20 or other components on top of itself. In some cases, active component(s) 20B of module 20 are not capable on their own of supporting additional modules 20 or components. In at least such cases frame 20A may be provided to provide strength and rigidity to module 20. In some embodiments, at least a portion of a module 20 replaces or reinforces a portion of frame 14 to minimize weight and volume of the locomotive while maintaining the structural integrity of frame 14.

In some embodiments, frame 20A is constructed around active component(s) 20B. In other embodiments, active component(s) 20B are installed within a pre-built frame 20A. Frame 20A may comprise a skeletal frame that allows access to active component(s) 20B, a solid frame that encloses active component(s) 20B entirely or some combination of both. For example, frame 20A may comprise ports, windows, doors, vents or the like for providing access to active component(s) 20B. Frame 20A may comprise one or more of: a monocoque structure, tubular members, I-beam members, plate members, gussets, trusses, and the like. Frame 20A may comprise metal or composite materials. For example, in some embodiments, frame 20A comprises a skeletal structure formed by a plurality of tubular steel members fastened to one another (e.g. by welding, bolting, riveting or the like). The shape, structure and material of frame 20A may be selected based on the type of active component(s) contained within the module 20 and the size and weight of other modules 20 that the module 20 is designed to support.

Frame 20A may also comprise one or more attachment points 20D. Attachment points 20D may be used to aid in affixing module 20 to chassis 10 or to other modules 20. Attachment points 20D may comprise, for example, tabs, apertures, bolt plates, weld plates, threaded openings, rails, loops, hooks or the like. In some embodiments, attachment points 20D comprise male or female connectors configured to matingly receive corresponding female or male members of another module 20 or chassis 10. In some embodiments, the chassis comprises one or more receptacle frames for receiving modules 20. For example, a receptacle frame may comprise one or more specialized mounting points or rails to slidingly receive a module 20.

Modules 20 may have any suitable shape, as desired for a particular application although it is typically convenient to provide modules 20 having outer envelopes in the form of rectangular prisms. This is not mandatory. Other prismatic shapes may be employed such as triangular or octagonal prisms.

Modules 20 may be dimensioned to make efficient use of space on chassis 10. For example, a module 20 may have a width substantially equal to that of chassis 10 or an integer number of modules 20 may fit across the width of chassis 10. Similarly, modules 20 may have lengths such that an integer number of modules 20 can fit into an available space (e.g. space 11A or 11B) on chassis 10. The height of modules 20 may be selected such that modules 20 may fit under frame 14 while leaving a required clearance or be mounted or stacked on top of frame 14 to reach a maximum height (such as a standard maximum locomotive height).

Interconnectors 20C of modules 20 may comprise various types of connections corresponding to the type of active component(s) 20B within module 20. For example, a fuel module 22 containing one or more fuel containers or the like as active component(s) 20B may have a fuel input/out interconnector 20C for receiving and delivering fuel and a sensor input/output interconnector 20C for transmitting fuel level measurements. In a power module 24, interconnector 20C may comprise one or more of, a fuel input, an exhaust output, a power output, electrical input and outputs, controller inputs and outputs and the like. Interconnectors 20C for various types of modules 20 are discussed in more detail below.

Active component(s) 20B may comprise, for example, one or more fuel containers for a fuel module 22, one or more engines and one or more generators or one or more fuel cells for a power module 24. Active component(s) 20B may further comprise ventilation systems cooling systems, or other support systems. Active component(s) 20B may be secured to frame 20A so as to protect active component(s) 20B from damage by movement during use.

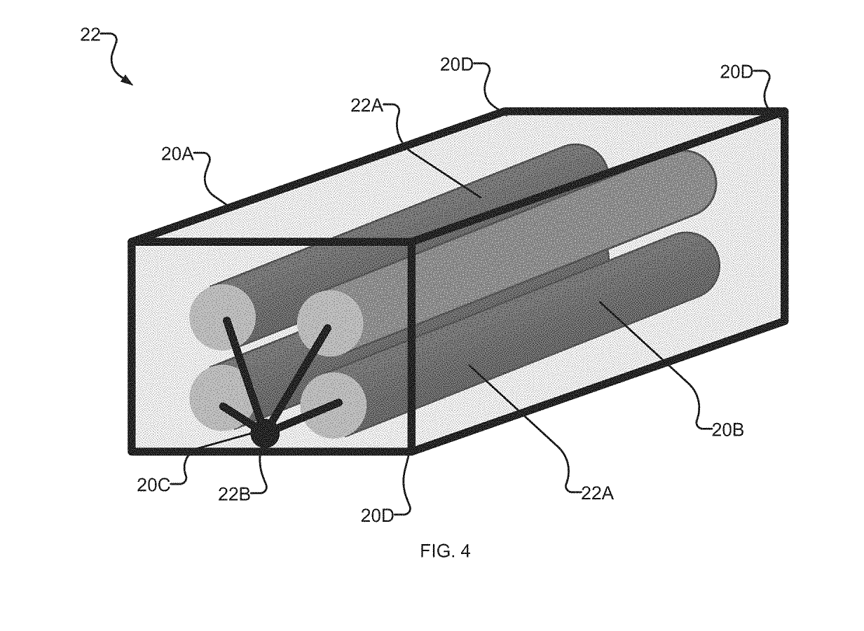

FIG. 4 depicts a fuel module 22 according to an example embodiment. Module 22 comprises a frame 20A housing active component(s) 20B and an interconnector 20C. In the illustrated embodiment, active component(s) 20B comprise fuel containers 22A. FIG. 4 depicts four fuel containers 22A within fuel module 22. A fuel module 22 may contain any suitable number of fuel containers 22A. In some embodiments, fuel containers 22A are of sufficient strength, rigidity and shape to be structural and a separate frame 20A may therefore not be required.

Each fuel container 22A may be configured to contain one or more gaseous fuels such as methane, natural gas, hydrogen gas, syngas, ethane, propane and other types of fuels that are in gaseous form at standard ambient temperature and pressure and/or one or more liquefied fuels such as pressurized liquefied propane gas (LPG), liquid natural gas (LNG), diesel fuel, gasoline, ethanol, biodiesel and oil. In some embodiments, gaseous fuels may be stored in liquid form. For example, propane or hydrogen may be stored in their liquid state. Depending on the fuel, fuel containers 22A may have different characteristics relating to volume, pressure capacity, shape, thermal insulation, cooling etc.

In some embodiments, fuel module 22 may be switched from containing a first type of fuel to containing a second type of fuel. For example, fuel modules 22 for natural gas may be similar or the same as fuel modules 22 for hydrogen. In some embodiments, it may be required to purge a fuel container 22A before switching the fuel type. For example, it is beneficial, in the case of hydrogen fuel cells, to use pure hydrogen devoid of contaminants such as other fuel types. In some embodiments, a complete purge of fuel module 22 is required to convert to a different fuel. A complete purge may, for example, require changing valves and other piping. A complete purge may be executed at ambient pressure. Some embodiments provide fuel modules equipped with refilling valving to facilitate purging with a fuel and/or with an inert gas or relatively inert gas.

In some embodiments, fuel containers 22A are configured to contain fuels at high pressures such as 5,000 PSI or higher. For example, compressed natural gas or gaseous hydrogen may be stored at high pressure. In other embodiments, the pressure capacity of fuel containers 22A may be lower such as in the range of approximately 1000 PSI and below. For example, adsorbed natural gas may be stored at pressures of approximately 900 PSI. In further embodiments, the pressure capacity of fuel containers 22A is between 1000 PSI and 5000 PSI. To facilitate storing fuel at high pressure, fuel containers 22A may be round in shape (e.g. cylindrical with rounded ends or spherical).

In some embodiments, liquid fuels are stored in fuel containers 22A comprising cryogenic cylinders. In other embodiments, liquid fuels are stored in fuel containers 22A comprising non-cylindrical cryogenic vessels. For example, liquid natural gas, liquefied hydrogen or other refrigerated forms of fuels such as ethane, propane, butane or even gasoline or diesel may be stored in such vessels. Because of the relatively lower pressure requirements for liquid fuels, fuel containers 22A may comprise non-round shapes. For example, the fuel container may be rectangular, triangular or generally polygonal in cross-section. Other fuels, such as adsorbed natural gas, may also be stored in non-cylindrical shapes, thereby maximizing the utilization of space aboard chassis 10.

Various materials may be employed to form fuel containers 22A. For example, fuel containers 22A may comprise steel, composite or some other material suitable for storage of liquids and gases, pressurized or not.

Fuel containers 22A may be of any suitable size. For example, in some embodiments, cylindrical fuel containers 22A have a diameter of between 25-35 inches and a length of approximately 90 to 120 inches. In other embodiments, fuel module 22 comprises a single larger fuel container 22A. In further embodiments, fuel module 22 may comprise several smaller fuel containers 22A. In some embodiments, a single fuel module 22 may contain fuel containers 22A of differing sizes (e.g. containing different fuels). The size of fuel containers 22A may depend on one or more of: the size of chassis 10, the location of fuel module 22 on chassis 10, the size of modules 20, the number of fuel containers 22A in each fuel module 22, the type of fuel being stored, etc.

Fuel module 22 may also comprise an interconnector 20C comprising a fuel input/output valve 22B. In some embodiments, fuel module 22 comprises one or more separate fuel input valves for filling and fuel output valves (i.e. for connection to a power module). Fuel valve 22B may comprise any type of valve, such as, for example: a ball valve, a butterfly valve, a disc valve, a check valve, a diaphragm valve, a gate valve, a globe valve, a knife valve, a needle valve, a pinch valve, a piston valve, a plug valve, a poppet valve, a spool valve, etc. In some embodiments, a single fuel valve 22B is provided for a plurality of fuel containers 22B while in other embodiments each fuel container 22B has its own valve. For example, in a fuel module 22 containing a single type of fuel, only a single fuel valve 22B may be provided on fuel module 22 while in an embodiment having multiple types of fuel in a single fuel module 22, a separate fuel valve 22B may be provided for each type of fuel.

To avoid filling a fuel container 22A with an incorrect type of fuel, some embodiments may comprise independent supply systems for each fuel type. Each independent supply system may be labelled and/or colored differently and/or may employ different fittings to avoid cross-contamination. In some embodiments, each individual fuel module 22 is filled by connecting a source of an appropriate fuel to a fitting on that fuel module. In other embodiments, a fueling system may be employed to fill all fuel modules 22 or groups of fuel modules 22 containing a particular type of fuel using a single input. The fueling system may comprise one or more input fittings for connection to appropriate fuel sources and a suitable arrangement of manifolds, conduits, pumps etc. to carry the fuel to the individual fuel containers 22A.

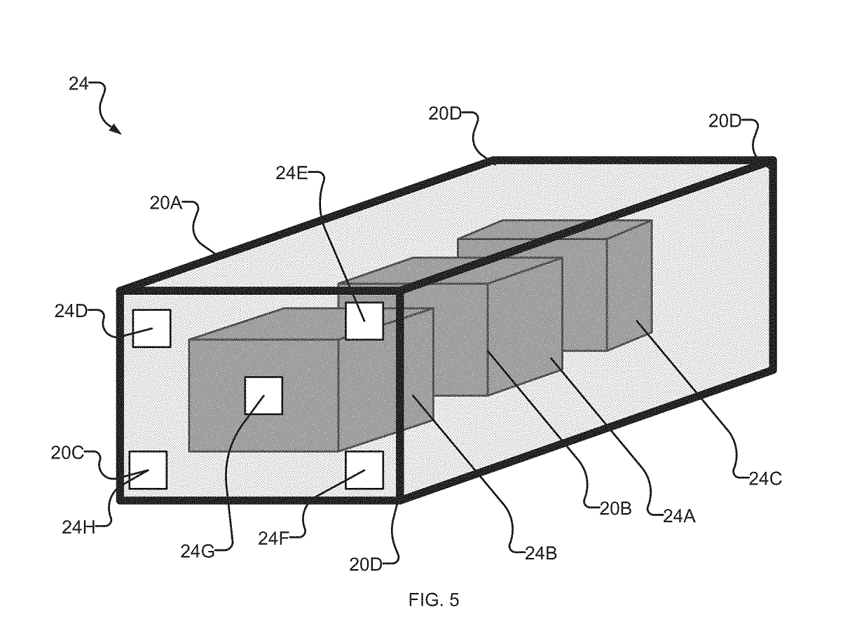

FIG. 5 depicts a power module 24 according to an example embodiment. Power module 24 comprises active components 20B including engine(s) 24A, generator(s) 24B and an optional cooling unit 24C. In other embodiments, active components may include more engines (i.e. two or more engines 24A). Active components 20B are housed within a frame 20A. Various interconnectors 20C may be provided as needed. For example, power module 24 may comprise a fuel input 24D, an exhaust output 24E, a ventilation output 24F, a power output 24G and/or a control input/out 24H. Active components 20B and interconnectors 20C may be arranged in any suitable geometry. In some embodiments, the organization of active components 20B may dictate the organization of interconnectors 20C while in other embodiments, necessary positioning of interconnectors 20C (for example, to allow connections with other modules 20) may dictate the arrangement of active components 20B.

In some embodiments, engine 24A comprises an engine optimized for a single fuel. For example, engine 24A may be an engine designed to use natural gas, as opposed to, for example, a diesel engine that has been modified to be compatible with natural gas. In some embodiments where it is desired to use multiple fuels, multiple engines, each optimized for a single specific fuel may be employed as opposed to a single engine that is merely compatible with multiple fuels (as opposed to being optimized for a single fuel). This may allow for use of stock engines for each fuel type without costly modifications.

Engine 24A may comprise a low weight and/or low volume high speed engine. A high speed engine is an engine that is capable of operating at over 2,500 RPM. Employing a low weight or low volume high speed engine may improve the power density of power modules 24 (i.e. the ratio of output power to weight or volume). Engine 24A may be designed to utilize various types of fuel. For example, in some embodiments, engine 24A uses natural gas, compressed natural gas, high density compressed natural gas, hydrogen or combinations thereof. In some embodiments a spark-ignition engine may run on multiple types of fuels without alteration. For example, some engines may be run using hydrogen fuel, natural gas or a combination thereof (e.g. hythane).

In some embodiments, low weight or low volume high speed engine 24A may comprise any of: a spark-ignition reciprocating piston internal combustion engine, a gas turbine type of internal combustion engine, a rotary internal combustion engine and a fuel cell. For convenience, a power module 24 in which engine 24A comprises a spark-ignition reciprocating piston internal combustion engine may be referred to as a spark-ignition power module, a power module 24 in which engine 24A comprises a gas turbine type of internal combustion engine may referred to as a turbine power module, a power module 24 in which engine 24A comprises a rotary engine may be referred to as a rotary power module and a power module 24 in which engine 24A comprises a fuel cell may be referred to as a fuel cell power module.

In some embodiments, engine 24A may comprise a spark-ignition reciprocating piston type combustion engine configured to operate over approximately 2,500 RPM at full load. In some embodiments engine 24A may operate at 8,000 RPM or more at full load. A preferred operating range of such an engine is the range of approximately 3,000 to 5,000 RPM.

In some embodiments, engine 24A comprise a rotary engine, such as, for example a Wankel rotary engine. A rotary engine may be configured to operate in the range of approximately 2,500 RPM to 8,000 RPM at full load. In some embodiments, a preferred operating range of such an engine is in the range of approximately 3,000 to 5,000 RPM. Wankel engines can generate relatively high power outputs for their size and weight. For example, a Wankel rotary engine approximately 30 inches, by 31 inches and 24 inches tall with a weight of 830 pounds may be capable of producing approximately 2,000 horsepower or more at between 8,500 to 9,000 RPM.

In some embodiments, engine 24A comprises a gas turbine internal combustion engine. A gas turbine rotary engine may be configured to operate for example in the range of 10,000 to 15,000 RPM at full load. In some embodiments, engine 24A may comprise one or more micro-turbine engines that may operate at even higher RPM. An example turbine engine is the Caterpillar™ Centaur 50™ gas turbine engine which may produce approximately 6,000 horsepower.

In some embodiments a power module may include a plurality of engines 24. A plurality of engines 24 may be provided where a single engine 24A may not have sufficient power capacity for a particular application. Where plural engines are provided, the engines may be identical, of the same type or different. For example, in one embodiment, first engine 24A comprises a V8 (or similar) natural gas powered spark-ignited reciprocating piston internal combustion engine capable of producing between approximately 400 to 800 horsepower (about 300 to 600 kW) and additional engine 24A also comprises a V8 (or similar) natural gas powered spark ignited reciprocating piston internal combustion engine capable of producing an additional 400 to 800 horsepower. In other embodiments, multiple types of engines 24A are provided in a single power module 24.

For certain applications it is desirable that each power module has a power output of at least 750 horsepower (about 560 kW). For example, in a power module comprising two engines, together a first engine 24A and an additional engine 24A may produce between 800 and 1600 horsepower (about 600 to 1200 kW). In other embodiments, a larger number of engines may be employed to achieve a similar power output. The number of engines may be selected based on, for example, the power density of different size engines, the complexity of interconnections 20C, the cost of individual engines etc.

In another example embodiment, a power module comprises two or more rotary or turbine natural gas engines working in unison to produce similar amounts of power.

In some power modules 24, engine 24A may comprise a compression-ignition engine (such as a diesel engine). Including a diesel power module in a locomotive advantageously allows the locomotive to revert to diesel fuel in case of emergency, failure of another engine or in the case that diesel fuel is available while other types of fuel are not. It is not necessary that a compression ignition power module be included on a locomotive according to the present invention. However, because of the modularity of the present invention, a compression ignition power module may be included without significantly increased cost or complexity.

In some embodiments, power module 24 comprises a cooling unit 24C to maintain a suitable temperature within the power module 24. Cooling unit 24C may comprise a heat exchanger, a radiator, a cooling fan or a combination thereof. In some embodiments, cooling unit 24C may function in conjunction with a ventilation output 24F and/or one or more additional ventilation openings. Cooling unit 24C may be positioned anywhere within power module 24. For example, cooling unit 24C may be positioned between a first engine 24A and an additional engine 24A. One or more cooling units may be positioned on top of, below or beside first engine 24A and/or additional engine 24A. Cooling units 24C may require a separate power source to function such as a common low voltage bus. Power for cooling unit 24C may be generated by an engine 24A or may be received from another source internal or external to the power module 24.

In an example embodiment, power module 24 comprise a pair of V8 spark-ignited reciprocating piston internal combustion engines, each capable of putting out approximately 600 horsepower. A radiator core 24C is provided for each engine. Radiator core 24C may be, for example, approximately 50-55 inches wide, 40-44 inches long and 5-10 inches thick. The size of radiator core 24C may be dependent on the time of engine used. For example, radiator core 24C may be relatively larger for diesel engines and relatively smaller for natural gas engines. For natural gas burning engines, a smaller radiator may be employed because of the increased exhaust temperature. The increased exhaust temperature of natural gas engines may also allow for the use of a three-way catalytic converter instead of other after treatment systems such as selective catalytic reduction.

Power module 24 may comprise one or more fuel inputs 24D. In some embodiments, there is a fuel input 24D for each engine (e.g. first engine 24A and/or additional engine 24A). In other embodiments, a single fuel input 24D provides fuel for all engines contained within power module 24. Fuel input 24 may comprise a releasable connector to facilitate installation and re-organization of modules 20. Fuel input 24D may be located to provide easy routing of hose or pipe between fuel modules 22 and fuel input 24D for transporting fuel.

Power output from engine 24A may comprise concentric rotary, eccentric rotary or reciprocating motion. In some embodiments generator 24B is connected to an intermediate gearing or transmission system to reduce or increase the speed of the power output from an engine 24A. Elimination of intermediate gearing or transmission systems may reduce costs, complexity, maintenance and space requirements thereby allowing a generator 24B and engine 24A combination to be more compact. In some embodiments, smaller high-speed generators are employed as they have greater power densities. A high speed generator is capable of operating at least 2,500 RPM. However, due to the availability of lower speed (e.g. approximately 1,500 to 1,800 RPM) generators, low speed generators may also be employed through use of intermediate gearing or transmission systems.

Generator 24B may comprise any device that converts mechanical energy to electrical energy. For example, generator 24B may comprise a direct current generator such as a dynamo, magneto, homopolar generator or a magnetohydrodynamic generator, a switched reluctance generator or an alternating current generator such as an induction generator, a linear electric generator or a variable speed constant frequency generator. In some embodiments, generator 24B is capable of producing in the range of about 200 kW to 5,000 kW. For example, a turbine engine may require a generator in the range of 3,000 kW to 5,000 kW.

In some embodiments, generator 24B comprises a regulator allowing generator 24B to supply power of any desired voltage independent of other generators 24B. A group of generators 24B may be regulated together so that overall current can be adjusted as desired. For example, it may be beneficial to provide current output at a constant voltage for powering systems such as cooling fans, air compressors, blowers etc.

Power output 24G may comprise an electric output. Power output 24G may be sealed to prevent ingress of unwanted contaminants within power module 24. In some embodiments, power output 24G is attached to additional power outputs 24G of additional power modules 24 either directly or via a transformer or the like.

Power modules 24 may deliver, as output, high voltage direct current. This output may be supplied to power a high voltage traction bus. The high voltage traction bus may then provide the electricity to drive traction drive system 16. In other embodiments, an alternating current high voltage traction bus system can be employed to drive traction drive system 16.

A power module 24 may also comprise a control input and/or output 24H for communicating with an operator or a control system. In some embodiments, control input and/or output 24H comprises a wireless connection such as, but not limited to, WiFi™, Bluetooth™, radio, infrared, ANT™, etc. Control input and/or output 24H may transmit information regarding the status of one or more engines 24, for example, engine temperature, engine efficiency, engine output, engine status, engine oil pressures, engine fuel pressure, exhaust gas temperature, exhaust levels, RPM, etc. as well as generator status information such as output current, output voltage, output frequency, windings temperature, etc. Additionally, control output 24H may receive instructions for fans, blowers, high voltage contactors and relays

In some embodiments, engine 24A of power module 24 comprises a fuel cell. Similar to internal combustion engines, fuel cells require a fuel input and oxygen input. Unlike internal combustion engines, fuel cells output electrical power instead of rotational or reciprocating power and therefore do not require a separate generator. For example, in some embodiments, engine 24A comprises a fuel cell connected to receive receiving fuel and an oxidant through fuel input 24D and connected to deliver electrical power to power output 24G. Fuel cells may run on any suitable fuel such as, for example, hydrogen gas, methane, natural gas, propane and butane. A single fuel cell power module 24 may comprise a plurality of fuel cells and use of individual fuel cells may be monitored and regulated to ensure balanced usage of each fuel cell.

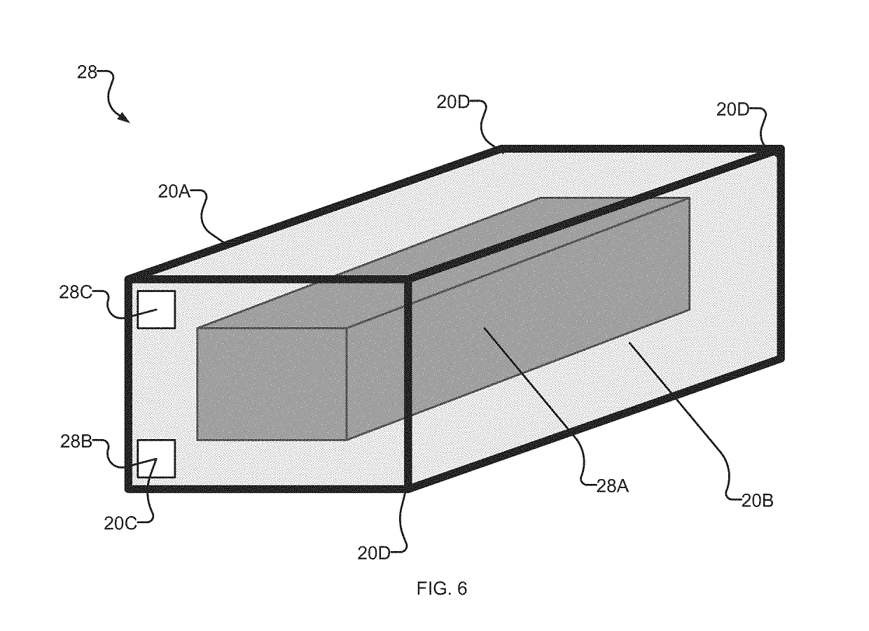

FIG. 6 depicts a battery module 28 according to an example embodiment. Active component 20B of battery module 28 may comprise one or more battery components 28A. Interconnector(s) 20C of battery module 28 may comprise one or more electrical inputs 28B and one or more electrical outputs 28C. Battery module 28 may also optionally comprise one or more cooling units such as a fan, ventilation, a heat exchanger, a radiator or the like (not depicted) and/or a battery management system.

Battery component(s) 28A of battery module 28 may comprise any suitable type of power storage devices. For example, battery component(s) 28A may comprise one or more of a capacitor or bank of capacitors, a super-capacitor, a flywheel, a lead acid battery, a nickel cadmium battery, a lithium-ion cell, or the like. Battery module 28 may comprise a battery management system to balance charging and draining of multiple cells within battery module 28. Battery modules 28 may further comprise a cooling system (e.g. an air or liquid based cooling system) to maintain a suitable temperature range within battery module 28.

In some embodiments, each battery component 28A may comprise a high capacity lithium-ion battery such as a Tesla™ battery. Such batteries may have a capacity of approximately 75-100 kWh. In some embodiments, sufficient battery component(s) 28A are employed in a battery module 28 to provide an energy storage capacity at least double the energy that battery module 28 is designed to provide so as to improve reliability, battery life and power availability for peak loads.

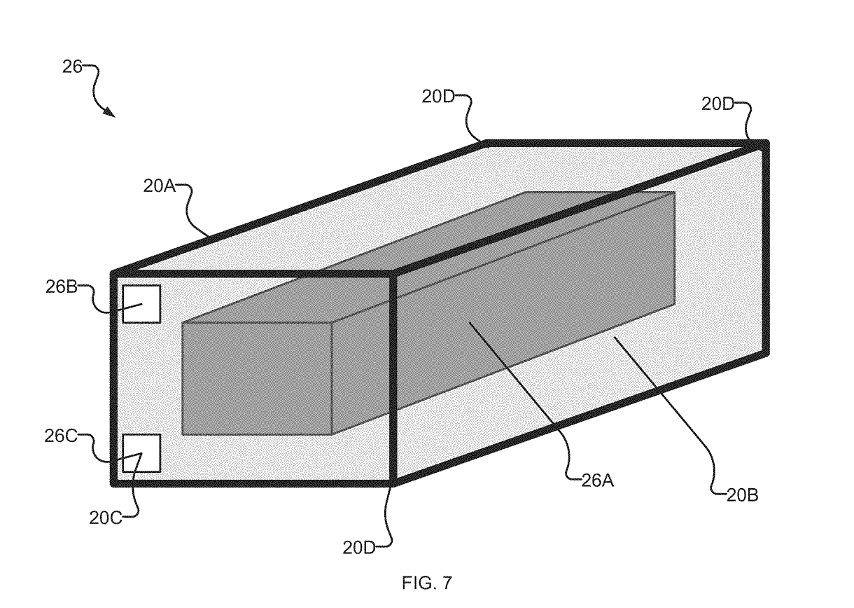

FIG. 7 depicts a generator module 26 according to an example embodiment. Active component 20B of generator module 26 may comprise one or more generators 26A. Interconnector(s) 20c may comprise a power input 26B and an electrical output 26C. Generator module 26 may also optionally comprise one or more cooling units such as a fan, ventilation, a heat exchanger, a radiator or the like (not depicted). Generator module 26 may be employed together with a power module that does not contain its own generator 24B. Generator 26A may be substantially similar to generator 24B.

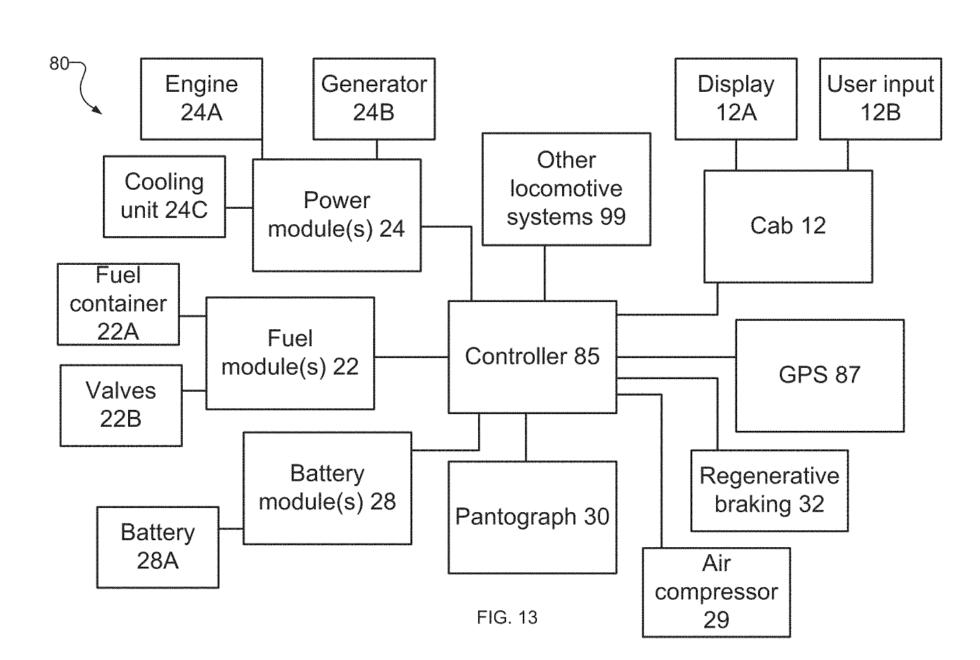

In some embodiments, modules 20 may comprise an air compressor module 29 (see FIG. 13). Air compressor module 29 may comprise an air compressor for a braking system (i.e. air brakes). Air compressor modules 29 may be located near cab 12 or opposite cab 12 near the back of a frame 14. Air compressor module may comprise any type of air compressor such as, for example, a piston type air compressor, a rotary screw air compressor or a vane compressor. Air compressor 29 may be directly powered by a power module 24 or may be powered from a low voltage bus, as described further herein. In some embodiments, air compressor 29 is replaced by bleeding off compressed air from a turbine power module 24. Air compressor may further be used to provided compressed air for an air starter. In such embodiments, air compressor module 29 may be part of a power module 24.

In some embodiments, modules 20 may comprise hybrid modules that combine features of, for example, power modules 24 and generator modules 26, power modules 24 and battery modules 28 or generator modules 26 and battery modules 28. Such hybrid modules may increase the efficiency of space utilization on chassis 10 and further expand the possible configurations for chassis 10.

Modules 20 may be positioned together on chassis 10 in any suitable configuration. Various example configurations are depicted and discussed herein for the purpose of illustrating example aspects of the invention. It should, however, be understood that additional configurations are feasible and are covered by this disclosure.

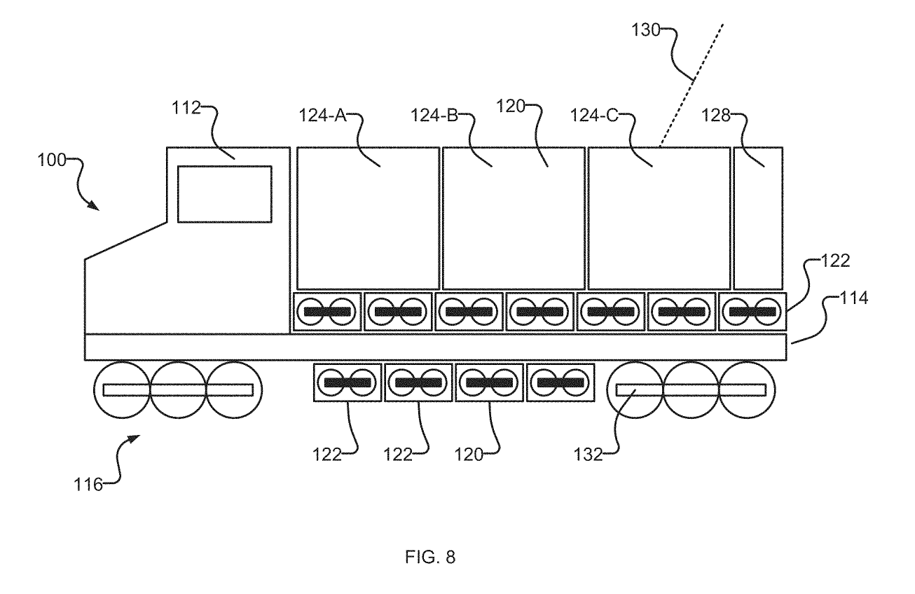

FIG. 8 depicts a locomotive 100 according to an example embodiment. Locomotive 100 comprises a chassis 110 having a frame 114 supporting a cab 112 and various modules 120. Modules 120 include three power modules 124 (i.e. power modules 124-A, 124-B, 124-C), eleven fuel modules 122 (seven fuel modules above frame 114 and four fuel modules below frame 114), an optional battery module 128 and an optional pantograph 130.

In FIG. 8, power modules 124 are mounted on top of the fuel modules 122 that are located above frame 114. Fuel modules 122 when coupled to frame 114 and/or to one another may provide a deck for supporting power modules 124. This may be possible due to the strength and rigidity of fuel modules 122 provided, for example, by frames 20A or fuel containers 22A themselves. In some embodiments, part of fuel modules 122 may constitute frame 114 or fuel modules 122 may comprise parts of frame 114. Mounting power modules 124 on top of fuel modules 122 allows for additional fuel storage aboard locomotive 100 and may negate the need for a fuel tender in some applications.

Due to the modularity of locomotive 100, it is possible to replace worn out, or outdated power modules 124 (and other modules 20) as needed. For example, as new technology becomes available, such as improved efficiency engines, it may be possible to swap out one or more power modules 124 to refurbish locomotive 100 and increase its useful lifetime.

Although FIG. 8 depicts there being four fuel modules 122 below frame 114 and seven fuel modules 122 above frame 114, any number of fuel modules 122 may be provided above and/or below frame 114 as the available space allows. For example, a larger number of smaller fuel modules 122 could be employed or a smaller number of larger fuel modules 122 could be employed. In other embodiments, some or all of fuel modules 122 could be replaced with battery modules 128. Alternatively, power modules 124, and battery modules 128 can be replaced with fuel modules 122. In essence, the modularity of the power and fuel supplies allows the design and configuration locomotive 100 to be fine-tuned for different applications.

Even in cases where power density of fuel modules 122 is less than the power density of diesel, by packing fuel modules 122 tightly, locomotive 100 may be able to hold sufficient fuel for extended operation. If natural gas fuel modules 22 (at 5,000 PSI) each comprise the equivalent of, for example, 200 gallons of diesel fuel, it is fairly straight forward to determine the number of natural gas fuel modules 22 required to match the fuel capacity of a diesel locomotive. Similarly, if hydrogen fuel modules 22 (at 5,000 PSI) each comprise the equivalent of, for example, 50 gallons of diesel fuel, it is fairly straight forward to determine the number of hydrogen gas fuel modules 22 required to match the fuel capacity of a diesel locomotive.

Although FIG. 8 depicts there being three power modules 124, any number of power modules 124 may be provided. For example, fewer or more than three power modules can be employed, if there is sufficient space. A locomotive without any power modules may serve as a fuel tender and/or a powered slug that draws electrical power from another locomotive. Such a locomotive may include one or more tiers of fuel modules 122 in place of the power modules 124 shown in FIG. 8.

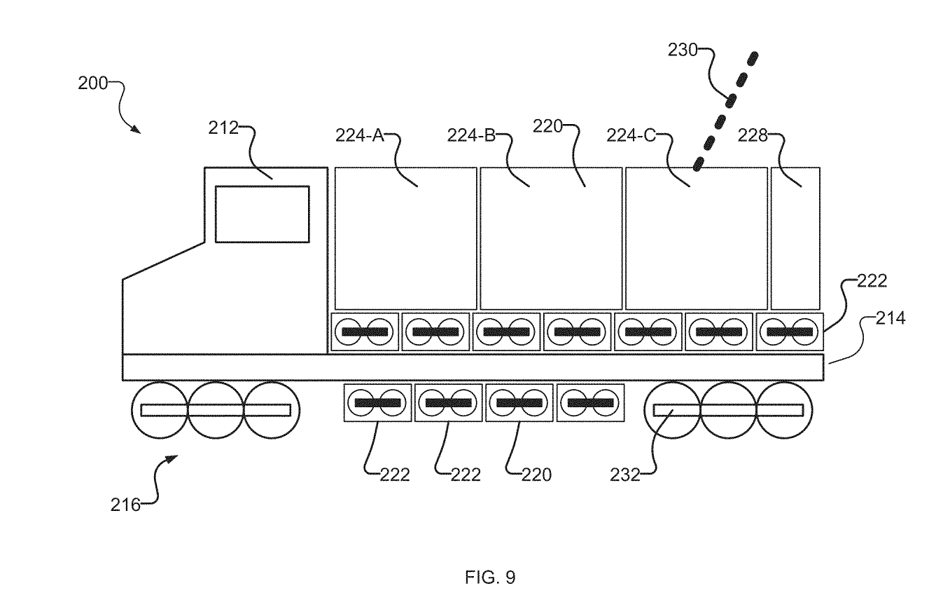

FIG. 9 depicts a locomotive 200 according to another example embodiment. Locomotive 200 comprises a chassis 210 having a frame 214 supporting a cab 212 and various modules 220. Modules 220 include three power modules 224 (i.e. power modules 224-A, 224-B, 224-C), fuel modules above frame 214 and fuel modules below frame 214, an optional battery module 228 and an optional pantograph 230.

Power modules 224-A, 224-B, 224-C each comprise spark-ignition power modules. Each spark-ignition power module 224 may run on natural gas, such as high density compressed natural gas stored in fuel modules 222, above and below frame 214. As compared to diesel locomotive engines, the use of high density compressed natural gas and spark-ignition power modules 124 may reduce NOx emissions and lower CO₂ emissions by approximately 20% or more or even 28% or more in some applications.

To provide locomotive 200 with sufficient power, each spark-ignition power module 224 may be capable of providing in the range of 1,000 to 1,500 horsepower (about 750 to 1100 kW) although some embodiments provide power outputs that are higher or lower than this range. The amount of power from each spark-ignition power module depend on the size of locomotive 200 and its intended applications.

As depicted in FIG. 9, a battery module 228 may be additionally installed on locomotive 200. Battery module 228 may receive excess power generated by power modules 224 and/or power from pantograph 230 for storage. Power stored by battery module 228 may then be directed to tractive drive system 216 in addition to the power from power modules 224 directed to tractive drive system 216 when additional power is needed, such as when going over an incline.

Battery module 228 may also receive power from a regenerative braking system. In some embodiments, locomotive 200 comprises a regenerative braking system 232. Regenerative braking system 232 may be similar to a dynamic braking system except that the electrical energy generated is captured and stored in battery module 228 for future use. In some embodiments, eight battery components 228A are provided in one or more battery modules 228 to provide a storage capacity of approximately 600 kWh to 1000 kWh. Battery modules 228 in other embodiments provide more or less energy capacity.

Instead of, or in addition to, battery module 228, locomotive 200 may also comprise an optional pantograph 230 extending from the top of locomotive 200. Pantograph 230 may allow excess energy to be exported to an external electric grid via a catenary. Locomotive 200 may comprise more than one pantograph depending on the amount of excess electric power generated to be transferred to the external grid. In some embodiments, electric energy is only transferred back to the grid when battery module 228 is full or near full. In other embodiments, excess electrical energy is transferred simultaneously to battery module 228 and pantograph 230. Alternatively, power may be provided from an external grid to locomotive 200 through pantograph 230.

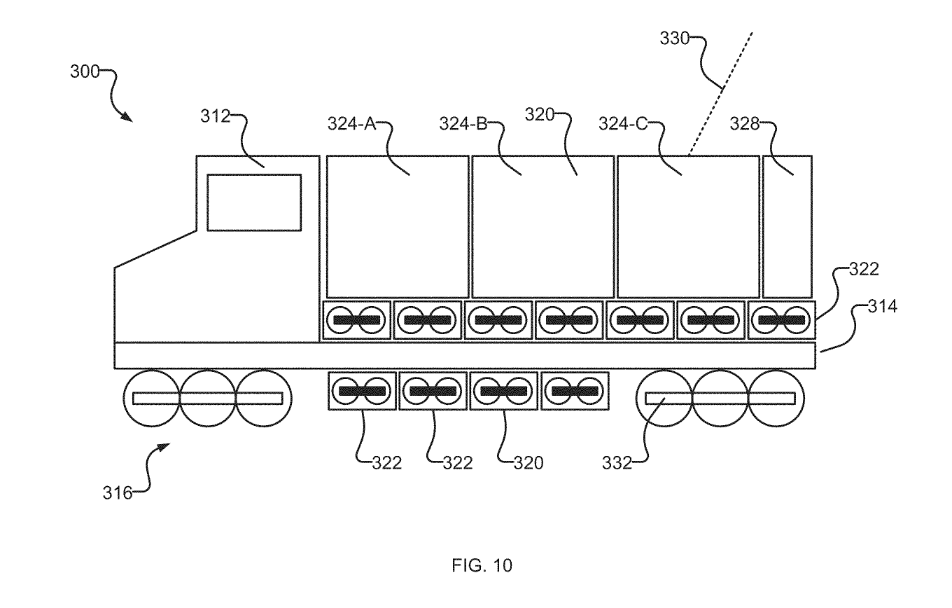

FIG. 10 depicts a locomotive 300 according to another example embodiment. Locomotive 300 comprises a chassis 310 having a frame 314 supporting a cab 312 and various modules 320. Modules 320 include three power modules 324 (i.e. power modules 324-A, 324-B, 324-C), fuel modules above frame 314 and fuel modules below frame 314, an optional battery 328 and an optional pantograph 330.

Power modules 324 comprise a combination of spark-ignition power modules and fuel cell power modules. For example, power modules 324-A, 324-B may comprise spark-ignition power modules while power module 324-C comprises a fuel cell power module. In such an embodiment, some fuel modules 322 may contain hydrogen fuel while other fuel modules 322 contain natural gas (compressed or otherwise). The proportion of hydrogen fuel modules 322 to natural gas fuel modules 322 is variable and may depend on the expected application of locomotive 300. In some embodiments, spark-ignition power modules 324-A and 324-B may run on hydrogen fuel at lower power outputs and on natural gas or a combination of natural gas and hydrogen at higher power outputs. Such an embodiment may comprise multiple fuel inputs 24D on each power module 124.

Providing multiple types of power modules 24, 124, 224 or 334 on a single locomotive 200 may be beneficial in limiting emissions of various pollutants as may be required by standards set throughout the world. For example, fuel cell power modules 324 and batteries 328 used without spark-ignition power modules 324 (when lower power is required) would allow for significantly reduced emissions in terms of NOx, particulate matter and CO₂. To achieve these benefits, it is not mandatory that engines and other power units be packaged in modules. Some embodiments provide locomotives which comprise power sources of a plurality of types or constructions.

Similarly, since multiple types of fuel are stored in fuel modules 322, the proportion of fuel types provided to spark-ignition power modules 324 can also be altered depending on power requirements to reduce emissions. For example, solely hydrogen may be used to satisfy lower power requirements and the amount of natural gas may be increased as the power requirements increase. Since hydrogen gas creates lower CO₂ and particulate matter emissions, this allows for emissions to be further reduced.

Similar to locomotive 200, locomotive 300 may comprise optional battery modules 328, regenerative braking 332 and an optional pantograph 330. Use of battery modules 328, regenerative braking 332 and pantograph 330 may be substantially similar to use of battery modules 228, regenerative braking 232 and pantograph 230.

In an alternative embodiment, one or more of power modules 324-A, 324-B is also a fuel cell power module. Two or three fuel cell power modules may be used to supply power to drive locomotive 300 in conjunction with increased battery capacity and other features such as regenerative braking 332 and pantograph 330.

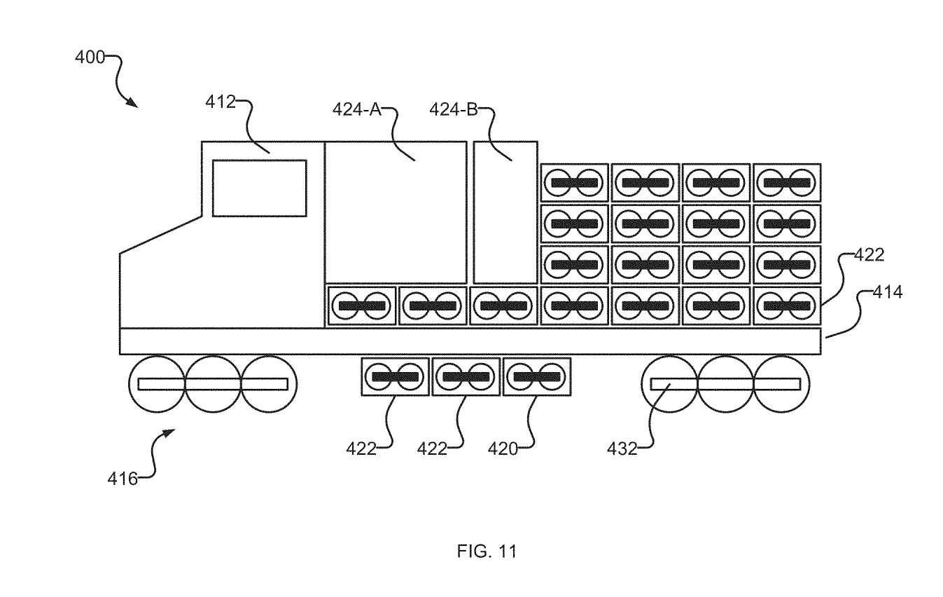

FIG. 11 depicts a locomotive 400 according to another example embodiment. Locomotive 400 comprises a chassis 410 having a frame 414 supporting a cab 412 and various modules 420. Modules 420 include a power module 424-A, an optional power module 424-B and fuel modules 422 above frame 414 and fuel modules 422 below frame 414.

Power module 424-A of locomotive 400 may comprise a turbine power module. Gas turbine engines, may not always achieve their maximum thermal efficiency levels at below approximately 30% to 50% of their rated maximum power output. Additionally, some emissions reductions technologies that may be employed with gas turbine engines for reducing NOx (such as Caterpillar™ SoLoNOx combustion control system) are only effective at 50% to 100% of maximum power output and only for turbines of approximately 4,700 horsepower or more.

Efficiency of power module 424-A may be improved by adding an optional power module 424-B, configured to be operated at lower power outputs (i.e. lower throttle notches) than power module 424-A, which may be operated at higher throttle notches, as discussed further herein. For example, power module 424-B may comprise a spark-ignited power module, a fuel cell power module or a rotary fuel module configured to be operated at lower power output than power module 424-A. In some embodiments, a higher output turbine engine and a lower output engine which are connected to drive the same or different generators provided in one power module (e.g. 424-A or 424-B).

As can be seen from FIG. 11, locomotive 400 is adapted for maximum fuel module 422 capacity. This allows for longer trips. In some cases a fuel tender may not be required, thus simplifying operations. Locomotive 400 may also supply fuel to additional locomotives, as discussed further herein.

In some embodiments a pre-existing diesel locomotive is modified to include features as described herein. For example, a locomotive may initially comprise two or more diesel engines. One of the diesel engines may be replaced with one or more modules as described herein. The second diesel engine may be retained. A locomotive modified in such a manner may provide operational advantages over the unmodified locomotive.

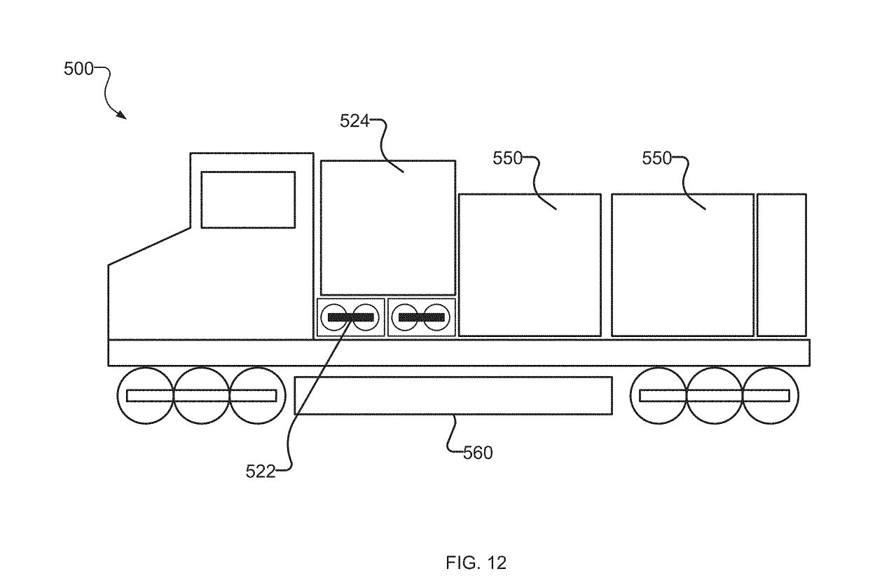

For example, FIG. 12 depicts locomotive 500 according to an example embodiment. Locomotive 500 comprises a chassis 510 having a frame 514 supporting a cab 512, two pre-existing diesel engines 550 and pre-existing diesel fuel storage 560. A single pre-existing diesel engine has been replaced by a power module 524 and two fuel modules 522. Fuel modules 522 are structural and support power module 524. Locomotive 500 has reduced reliance on diesel fuel and increased efficiency and/or reduced emissions as compared to an unmodified version of locomotive 500. Further locomotive still allows for an locomotive 500 to fall back on diesel fuel power should a failure occur or should gaseous fuel not be readily available.

Power module 524 may comprise any suitable power module 24 discussed herein. Power module 524 may run on hydrogen, natural gas, hythane or the like. At lower power, which may represent a majority of the usage of locomotive 500, it may be possible to run entirely using power module 524 and not pre-existing diesel engine(s) 550. For example, in some embodiments, power module 524 may output approximately 1,000-1,500 horsepower while pre-existing diesel engines 550 output approximately 450 horsepower each. In such embodiments, the additional power provided by pre-existing diesel engines 550 may be unnecessary during the majority of use of locomotive 500. In this way, emissions may be significantly reduced as compared to the pre-existing pure diesel engine locomotive.

In some embodiments, locomotive 500 is further modified to comprise additional fuel modules 522. For example, pre-existing diesel engines 550 may be raised and supported by additional fuel modules 522 for power module 524. In some embodiments, a second pre-existing diesel engine 550 is replaced by an additional power module 524 or additional fuel modules 522 to increase the power of locomotive 500 or the range of locomotive 500.

In some embodiments, a pre-existing locomotive having a single diesel engine is retro-fitted to remove the pre-existing diesel engine and replace it with a power module 24, as described herein. Additionally, pre-existing parts of the locomotive, such as fuel storage may be raised and supported by additional fuel modules 22. In particular, an EMD model GP7/8/9/10 or an EMD model SW1200 could have its respective single diesel engine replaced with a power module 24 and have its fuel tank raised above and supported by a plurality of fuel modules 22.

Locomotive 100 (and any other locomotive herein) may comprise a control system 80 operable for managing locomotive systems, including power modules 24, generators, fans, air compressors, main traction contactors, auxiliary devices and the like. Such control systems may also have application in other contexts. For example a control system adapted to control engines of different types to generate power for driving a locomotive may be used whether or not the engines are provided in modular units. Similarly, such control systems may have application in ships, generator stations or other installations where power is generated.

Control system 80 may further comprise displays and controls to allow an operator to monitor the various systems and take control if, and when necessary. Central control system 80 may comprise a two-way communication between locomotive components (e.g. modules 20 and cab 12) via a controller area network vehicle bus standard. In some embodiments, two way communication between modules 20 and cab 12 is wireless (e.g. WiFi™, Bluetooth™, radio, infrared, ANT™, etc). Control system 80 may, for example, communicate power settings to power modules 24, voltage settings to generators 24B, speed settings to motors 24A and receive status updates from the same.

FIG. 13 depicts a control system 80 according to an example embodiment. Control system 80 comprises a controller 85 connected to modules 20 and cab 12. Controller 85 may be connected to power modules 24 via control input/output 24H thereby allowing communication with, for example, engine 24A, generator 24B, power output 24G, cooling unit 24C, fuel modules 22 and battery modules 28. Controller 85 may be connected to fuel modules 22, thereby allowing communication with fuel containers 22A and fuel valves 22B. Controller 85 may be connected to battery modules 28, thereby allowing communication with battery components 28A, input 28B and output 28C. The connection between controller 85 and cab 12 may allow communication with display 12A and allow receipt of user input 12B. Additionally, controller 85 may be connected to regenerative braking system 32, air compressor module 29 and pantograph 30. As discussed above, one or more of such connections may comprise wireless connections.

Control system 80 may be employed to control many aspects of modules 20 and other locomotive systems 99 without user input (while simultaneously allowing an operator to monitor the status of modules 20 and other locomotive systems 99). Alternatively, control system 85 may be configured to receive substantial amounts of user input 12B for control of modules 20 and other locomotive systems 99.

In some embodiments, control system 80 may automatically recognize modules 20 and locomotive systems 99 and configure itself to cooperate with, monitor and optionally control the recognized modules 20 and systems 99. In this way a control system 80 may be applied to locomotives having a wide range of different configurations of modules 20 without significant modification to the control system.

Control system 80 may be controllable, accessible and/or updatable, either by wired connection or wirelessly. For example, it may be beneficial for a railroad to be able to transmit new operating parameters to control system 80 in real time to improve or vary power output or emissions.

Control system 80 may comprise a positioning module 87 to allow control system to automatically vary commands based on a geographic location. Position module 87 may comprise a satellite module such as a GPS module, a GLONASS module, an IRNSS module, a GNSS module or a GALILEO module or may comprise a non-satellite module such as a quantum compass which relies on subatomic effects on Earth's magnetic field, All Source Positioning and Navigation which relies on a series of self-calibrating gyroscopes, accelerometers and clocks or Chip-Scale Combinatorial Atomic Navigator systems that relies on atomic inertial measurements. For example, control system 80 may be configured to lower power output, emissions (noise and/or pollution) within particular city limits and to raise power output (potentially at the cost of increased emissions) outside of city limits. Such operational modes may facilitate compliance with regulations regarding emissions and/or noise. As another example, control system 80 may be configured to automatically start a power module at a location that is in advance of a location at which the output of the power module will be required. For example, of the output of one power module is sufficient in a flat area but a hill is coming up in which the output of two power modules will be required, control system 80 may automatically start a second power module so that the second power module will have had a chance to warm up by the time the hill is reached.

In some embodiments, control system 80 is configured to balance the relative strengths and weaknesses of different types of power modules 24 present on a single locomotive (or in a locomotive combination). For example, in some embodiments, it may be advantageous to utilize a first power module 24 at low power requirements and second power module 24 when the power requirements are increased and possibly both power modules when the power requirements are increased further.

In some embodiments, control system 80 is configured to select a power output level for each power module 24 present on a locomotive. Control system 80 may select the power level outputs based on a variety of factors, each factor biasing the power level upward or downward (or neutrally in some cases). In some embodiments, where there is only a single factor biasing may result in optimization of the single factor. In embodiments, having multiple factors, biasing may be accomplished according to pre-selected priorities. In some embodiments, control system 80 selects the power level outputs based on a comparison of one or more characteristics of a fuel of a first power module compared to one or more characteristics of a fuel of a second power module. In some embodiments, more than two fuels and/or two power modules are considered and compared.

Traditionally, locomotives operate at eight discrete throttle settings (as opposed to a continuously variable throttle). In some cases, emissions testing is based on a total emissions output using approximate lengths of time that a locomotive is expected to spend at each throttle setting. In order to minimize the total emissions output, system 80 may be configured to use different power modules 24 in different proportions and/or combinations at different throttle settings. For example, for a throttle setting that is expected to be used for the longest amount of time, the lowest emissions power modules 24 may be relied upon. This may include relying on battery module 28 heavily during some throttle settings and not at all during other throttle settings.

Control system 80 may be configured to use a fuel cell power module 24 and battery modules 28 at the lowest throttle levels (e.g. up to notch 4) to produce a minimal amount of CO₂ and NOx emissions. At notch 5, a natural gas engine, such as a rotary power module 24 or a spark-ignition power module 24 may be added to achieve the desired power level. At notch 5, the natural gas engine may contribute any portion of the overall power being produced, as desired. Through to notch 8, the amount of power drawn from the natural gas engine may be increased. Alternatively, if the amount of power drawn from fuel cell module 24 and battery module 28 was decreased at notch 5, power drawn from all power modules 24 and battery module 28 may be increased at higher notches. Similarly, the fuel cycle can be altered depending on the emissions testing requirements and the configuration of the locomotive. For example, a locomotive having a turbine engine may require a different fuel cycle completely.

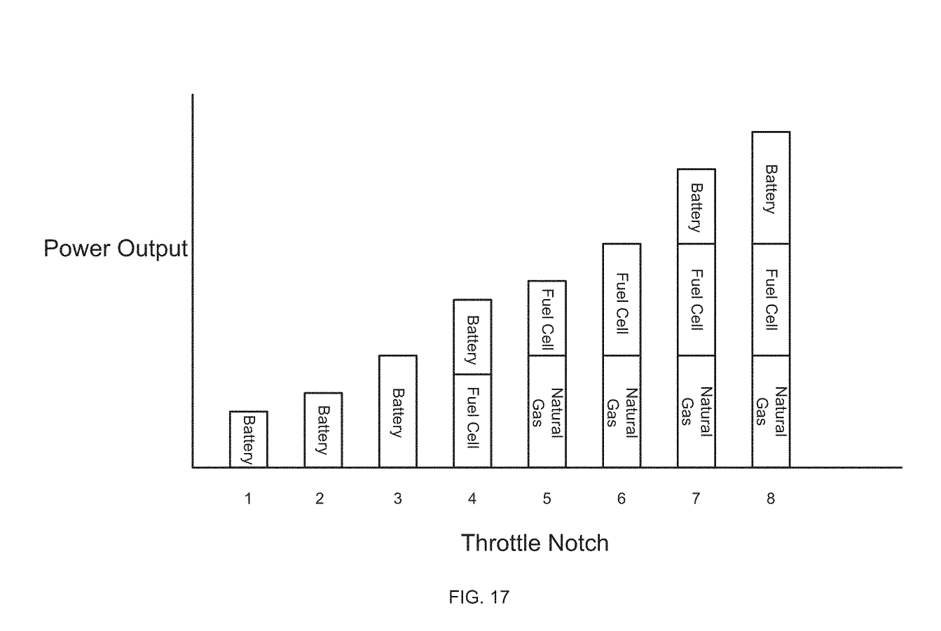

FIG. 17 is a bar graph representing the relative proportion of power supplied at each throttle notch by each power module according to an example embodiment. FIG. 17 corresponds to a locomotive comprising one natural gas module 24 (e.g. a spark-ignition power module 24, rotary power module 24 or a turbine power module 24), one fuel cell module 24 and one battery module 28. As can be seen from FIG. 17, at notches 1 to 3, the locomotive relies solely on battery power, thus creating no emissions. At notch 4, fuel cell power module 24 and battery module 28 split the load approximately evenly. To save battery power for later use, notch 5 relies on a split between fuel cell power module 24 and natural gas power module 24. In this embodiment, natural gas module 24 is always run at or near full power. This is not mandatory but may be beneficial for a turbine power module 24 which is less efficient at lower power outputs. Throttle notch 6 similarly relies on both natural gas fuel module 24 and fuel cell module 24 at full power. Throttle notch 7 adds in some output from battery module 28 while throttle notch 8 relies on maximum output from all three. While FIG. 17 depicts one exemplary embodiment of the relative proportion of power supplied at each throttle notch by each power module 24, it should be understood that any other configuration could be implemented depending on the desired power profile, emissions profile, fuel storage, terrain etc. Furthermore, similar configurations could be imagined for locomotives having different combinations of power modules 24, such as are described herein.

Regarding the FIG. 11 embodiment of locomotive 400, comprising a turbine power module 424-A and a secondary power module 424-B (such as, for example, a spark-ignited power module, a rotary power module or a fuel cell power module), it may be beneficial to employ the secondary power module 424-B at lower throttle levels and the turbine power motor 424-A at higher throttle levels. In this way, inefficient thermal functioning of the turbine power module 424-A at low power outputs (e.g. below 30-50% of maximum) is avoided by relying on the low emission, low power secondary power module 424-B. When additional power is required (e.g. power beyond the capacity or near the capacity of secondary power module 424-B), the turbine power module 424-A may be employed to meet the added power needs. Alternatively, a locomotive 400 could rely on an external power source for lesser power needs, such as power received from an external grid through a pantograph 430. In some embodiments, power stored in a battery module 428 is employed below a threshold power requirement at which turbine power module 424-A operates sufficiently efficiently.

In some embodiments, locomotive 100 (or any other locomotive herein) may operate in a hybrid mode. Control system 80 may be configured to maximize usage of battery module 128 to thereby minimize fuel consumption. Control system 80 may be configured to rely on both power module 124 and battery module 128 during peak power needs, allowing for a smaller, less powerful power module 124. Control system 80 may also be configured to activate regenerative braking system 132 to recapture energy for storage in battery module 128 to improve energy efficiency. In low power situations, control system 80 may be configured to shut down one or more power modules 124 completely to rely solely on battery module 128.

In some embodiments, each power module is configured to run with a single type of fuel. For example, in one embodiment, a natural gas power module 24 optimized to run on natural gas (as opposed to a non-natural gas engine that has been modified to run on natural gas) might be used to supply all or at least a majority of the power for locomotive 100 at lower throttle notch settings while a diesel power module 24 optimized to run on diesel is used for power above a pre-set power threshold (i.e. at higher throttle notches). The diesel power module 24 could alternatively be used if the natural gas module 24 became inoperable due to mechanical difficulties or lack of natural gas fuel. In this way, the diesel power module can be employed to boost power or as a backup power source while the natural gas power module 24 is the primary power source. This may allow for fewer emissions and/or reduced operating costs without reducing reliability.

In some embodiments, control system 80 is configured to run particular power modules with different fuels and/or combinations of fuels. For example, gaseous internal combustion engines as discussed herein may be configured to run on hydrogen fuel up to a certain power level and hythane (a combination of hydrogen and methane or natural gas) at higher power levels. The hythane fuel mixture may be created by employing multiple sets of fuel injectors or by mixing fuels before injection (e.g. in the supply lines). Control system 80 may be employed to control the mixture (e.g. by controlling fuel valves) and ensure that desired ratios of fuels are achieved. In this way, emissions can be further reduced over traditional diesel locomotive engines. In some cases, the reduction of CO₂ is greater than 20% and may be as high as 50% for particular applications.

In some embodiments, control system 80 is configured to monitor the status of modules 20, such as fuel modules 22, power modules 24 and battery modules 28. In some embodiments, monitoring the status of modules 20 requires user input while in other embodiments, control system 80 is configured to monitor modules 20 automatically. This may include monitoring fuel levels of one or more types of fuel, whether a power module 24 is functioning properly and the energy levels of battery modules 28. Using such information, control system 80 may be configured to compensate for a failing power module 24 by relying on other power modules 24 or may switch from one fuel type to another fuel type to maximize use of remaining fuel. In addition to monitoring and accounting for local parameters, control system 80 may also account for external parameters such as the geography of the route and the length of the route.

In some embodiments, control system 80 may be capable of operating in different modes. Each mode may be configured to optimize operation of power modules 24 and other train systems according to one or more prioritized factors. For example, modes of operation of control system 80 may include: an emission reduction mode, a cost reduction mode, a fuel consumption reduction mode, a noise reduction mode and various combinations thereof. In some embodiments, control system 80 may operate in a combined mode that prioritizes emission reduction, cost reduction, fuel consumption reduction, noise reduction according to pre-set priorities. In some embodiments, each mode is of equal priority while in other embodiments, the priorities may vary based on external factors such as geographic location of locomotive 100 and/or regulations.

An emissions reduction mode may include prioritizing employing low emissions power modules such as battery module 28 and fuel cell module 24 over higher emissions modules such as a natural gas module or a diesel engine module. For example, the control system may store pollution emission information for each power module 24. The pollution emission information may be based on one or more measurements taken of power module before installing on locomotive 100 and/or measurements taken by one or more emissions sensors connected to control system 80 during operation of power module 24. The pollution emission information may be different depending on the power output level of power module 24 and may be stored as a function or look up table based on power output level. The emissions reduction mode may comprise control system 80 biasing power output to optimize the total emissions of two or more power modules based on a comparison of the pollution emission information of each power module 24. Pollution emissions may include, but are not limited to, carbon dioxide emissions, greenhouse gases, particulate matter, sulfurs, volatile organic compounds, carbon monoxide etc.

A cost reduction mode may comprise determining the cost of each fuel source (e.g. hydrogen fuel, natural gas, diesel fuel, hythane etc.) and prioritizing the fuels that have the least cost per amount of power provided. Cost reduction mode may optionally also account for the cost of maintenance for each power module and the likelihood of required maintenance based on the mileage and/or operating hours and/or power output of a particular power module. In this mode, use of a particularly high maintenance power module may be avoided to reduce costs. The cost reduction mode may account for the price paid for fuel that is already onboard locomotive 100 and may use known costs for refueling (e.g. either real time or updated on a regular basis).

A fuel consumption reduction mode may include limiting the amount of total fuel used to thereby increase the maximum attainable distance. This mode may incorporate lowering power output pre-emptively to reduce the use of brakes and/or reducing overall speed and/or biasing a selection of power modules in favor of power modules with the greatest fuel efficiency or with the greatest onboard fuel level. The onboard fuel level of fuel modules 22 may be measured by one or more sensors connected to control system 80.

In some embodiments, control system 80 monitors and records the fuel efficiency of each power module 24 at various power outputs and temperatures. Based on the recording fuel efficiency, updated over time, control system may bias power output levels to make use of the most efficient power outputs of each power module 24. In some embodiments, this may require running a particular power module at a higher power than necessary and storing excess energy because it is more efficient in the long run.

In some embodiments, control system 80 comprises a database of a plurality of known fueling stations for one or more types of fuel onboard locomotive 100. Using positioning module 87, control system 80 may determine the distance along the track to the next fuel station for each type of fuel onboard locomotive 100. To make the most use of available fuel stations, control system 80 may be configured to bias fuel usage to use the fuels that are most readily available for refueling.

A noise reduction mode may comprise prioritizing use of quieter power modules such as battery module 28 and fuel cell module 24 over louder power modules such as natural gas modules, diesel modules and other internal combustion engines. This mode may be employed, for example, within city limits or in other noise regulated areas. In some embodiments, one or more power modules 24 may comprise an ambient noise sensor for determining an overall ambient noise emission of each power module. If the ambient noise of locomotive 100 reaches a set threshold, control system 80 may be configured to bias power output to the power module which has a lower measured ambient noise emission. The noise threshold may vary based on geographic location. For example, in residential neighborhoods, the threshold may be lower than in industrial areas. In some cases, the noise threshold may be set by one or more regulatory bodies or may be set as lower than the regulatory limit to avoid surpassing the regulatory limit.

In some embodiments, internal combustion power modules 24 may be started, for example, using starter motors (not depicted) configured specifically for the purpose of starting the locomotive. In other embodiments, generators 24B may be configured to receive electrical power (e.g. from battery modules 28 or another source) and to output rotational power to initially drive engines 24A. As engine 24A begins to rotate, fuel mixed with air is supplied into the combustion chambers and ignited to begin the engine cycle. In other embodiments, a compressed air driven engine starter may be employed.

In some embodiments, a separate low voltage bus is provided to power control system 80, fans, air compressors and other auxiliary devices. This low voltage bus may be alternating current or direct current. This low voltage bus may also be used to power a starter inverter for powering generator 24B to start engine 24A. In other embodiments, an auxiliary generator is powered by the low voltage bus and connected to engine 24A to start engine 24A. The auxiliary generator may be smaller than generator 24B and may require less power to start engine 24A than using generator 24B which may not have available power from the high voltage bus. Additional batteries may be connected to the low voltage bus to provide power for the auxiliary generator or the starter inverters. By employing generator 24B to start engine 24A the engine can be quickly spun up to a high RPM. Starting the engine at a higher RPM may reduce wear on the engine, increase engine life, and may reduce emissions associated with engine startup.

In practice, locomotive 100 (and other locomotives described herein) may be employed alone on a train or together with one or more additional locomotives and tenders. A set of locomotives under multiple unit control may be referred to as a “consist”. Similar to the modularity of individual locomotives described herein, a consist may comprise various combinations of locomotives. Each of the locomotives in the consist may optionally have a different combination of power modules 24, fuel modules 22, battery modules 28, etc. Consists can comprise two or more than two locomotives. Locomotives can be adjacent one another or spaced along the train. By combining similar or different locomotives, it may be possible to achieve improved fuel consumption and reduced emissions for various applications.

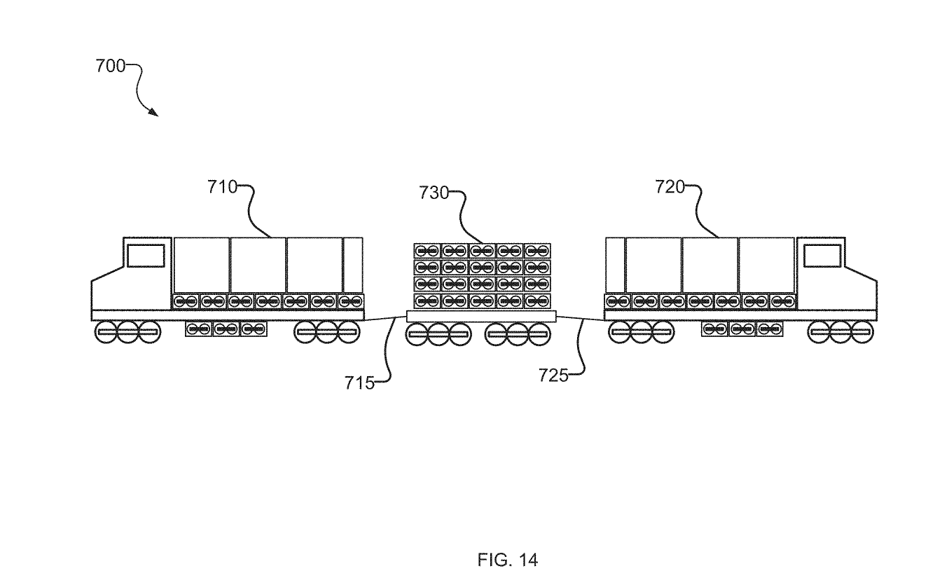

FIG. 14 depicts a consist 700 according to an example embodiment. Consist 700 may comprise a first locomotive 710, a second locomotive 720 and a tender 730. First locomotive 710 is connected to tender 730 by a first coupling 715 and tender 730 is connected to second locomotive 720 by a second coupling 725. As can be seen from FIG. 14, the direction that a locomotive faces is not mandatory, unless the locomotive is the lead unit. In the case of lead units, it is beneficial that the cab faces forward, allowing an operator to look ahead. In some embodiments, it may be beneficial to also have a rearward facing cab to ease switching operations and the like.

First locomotive 710 may comprise a locomotive according to any embodiment described herein. In particular, locomotive 710 may comprise any of power modules 24, fuel modules 22, battery modules 28 and other features described herein. Similarly, second locomotive may comprise a locomotive according to any embodiment described herein.

Tender 730 may comprise a traditional fuel storage tender or may be configured to receive one or more fuel modules 22 in various configurations. Tender 30 may contain one or more types of fuel. For example, if locomotive 710 uses a first fuel and locomotive 720 uses a second fuel, tender 30 may comprise some amount of each fuel. In some embodiments, where locomotives 710, 720 operate using more than two types of fuel, tender 30 may optionally contain more than two types of fuel. Tender 30 may also have powered traction motors to be powered by locomotives 710 and/or 720 by electrical power delivered across couplings 715, 725.

Couplings 715, 725 may comprise traditional multi-unit train control couplings or an improved coupling described herein. In some embodiments, couplings 715, 725 comprise a gaseous fuel connection. The gaseous fuel connection may be pressurized (since the fuels are stored pressurized) and therefore may not require a pump to deliver fuel to locomotives 710, 720. The pressurized nature of the fuel supply may also allow for equalized fuel delivery across multiple locomotives (e.g. locomotives 710, 720 or more). In this way, no single locomotive will run out of fuel before another locomotive in consist 700. This may increase the range of consist 700.

In an exemplary embodiment, locomotives 710 and 720 are each powered solely by natural gas or compressed natural gas. Tender 730 contains solely natural gas or solely compressed natural gas. In another embodiment, locomotive 710 is powered by natural gas while locomotive 720 is powered by multiple fuels (such as natural gas and hydrogen). In this case, tender 730 may contain both natural gas and hydrogen and coupling 725 may include multiple fuel connections, one for each type of fuel.

Since locomotives 710, 720 are not necessarily identical, it may be beneficial to run locomotives 710, 720 at different throttle settings simultaneously. In some embodiments, couplings 715, 725 also comprise connections for control system 80 to allow individual control of all power modules 24 across consist 700. In other embodiments, control system 80 may control all power module 24 (or at least some power modules 24) across consist 700 wirelessly. Control system 80 may be employed to optimize power module 24 usage according to economics (i.e. the cost of fuel and/or the cost of fuel plus the cost of wear and tear on individual power modules), performance, reduction of particular emissions, overall reduction of emissions, bias towards a particular fuel type (e.g. because of limited supply), or any combination of the above and like factors. Further, different factors may be attributed with different levels of priority depending on location, time, type of cargo, amount of cargo or other preferences. For example, CO₂ and NOx emissions may be more important to reduce during certain times of the day or the year or in certain locations (such as urban areas).

In some embodiments, locomotives 710, 720 may employ power sharing. In this way, either of locomotives 710, 720 may supply power across couplings 715, 725 to the other locomotive. Such a relationship can be employed during certain times while during other times, both locomotives may supply power. In this way, running power modules 24 on both locomotives 710, 720 can be avoided if possible to reduce fuel consumption and emissions. In such a scenario, power connections across couplings 715, 725 may be coupled to the high voltage traction bus of locomotives 710, 720 as opposed to being directly coupled to the traction motors to allow for proper control by control system 80.

For example, locomotive 710 may comprise a gaseous fuel powered locomotive 100 or another locomotive as described herein while locomotive 720 comprises a traditional diesel-electric locomotive or a dual fuel diesel-electric locomotive. In this example, the gaseous fuel locomotive 710 may supply all the necessary power to move consist 700 and may augment its tractive effort by using the traction motors of the diesel-electric (or dual fuel diesel-electric) locomotive 720—whose normally higher polluting engine has been shut down. During this operation the diesel-electric (or dual fuel diesel-electric) locomotive 720 serves as a slug to the gaseous fuel locomotive 710 mother. When consist 700 requires the full power of the consist, such as, but not limited to, when the train returns to the main line, or ascends a steep grade, the diesel-electric or dual fuel diesel-electric locomotive(s) engine(s) is/are started and locomotive 720 no longer functions as a slug in the consist. Locomotive 710 may supply locomotive 720 with fuel, as necessary.

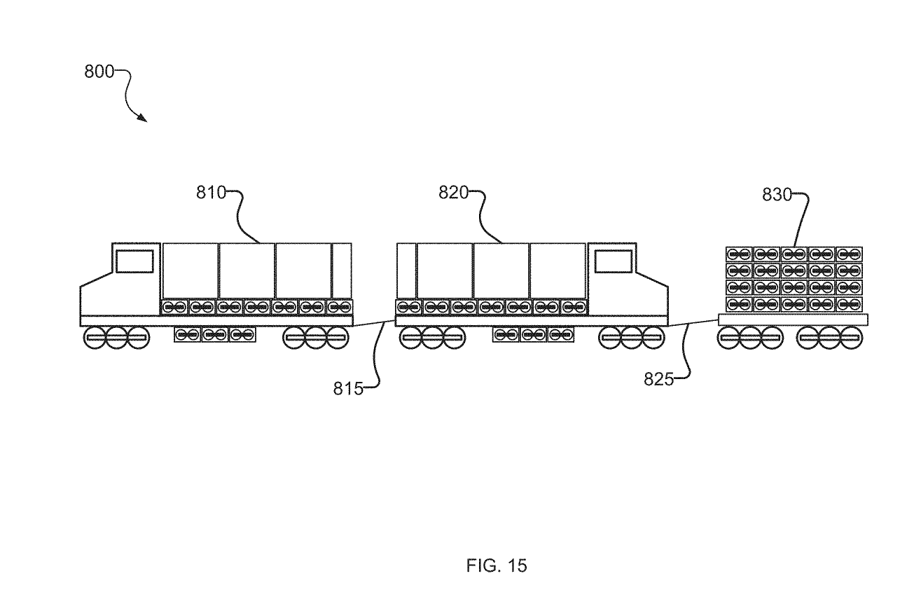

FIG. 15 depicts a consist 800 according to another example embodiment. Consist 800 comprises a first locomotive 810 coupled to a second locomotive 820 by a first coupling 815 and a tender 830 coupled to the second locomotive 820 by a coupling 825. Consist 800 is substantially similar to consist 700 except that the relative positions of tender 830 and second locomotive 820 have been swapped. Although this embodiment is feasible, it may require fuel to for locomotive 810 to be transferred across locomotive 820, thereby increasing the costs and complexity of such a design.

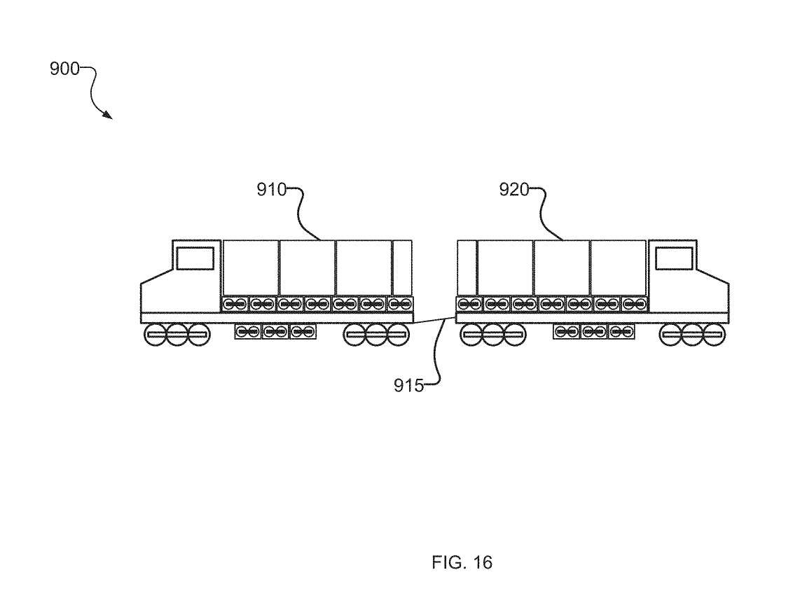

FIG. 16 depicts a consist 900 according to another example embodiment. Consist 900 comprises a first locomotive 910 coupled to a second locomotive 920 by a coupling 915. Consist 900 is substantially similar to consists 700 and 800 except that there is no tender. Nonetheless, fuel may be transferred between locomotives 910, 920 by way of coupling 915.

In some embodiments, first locomotive 910 comprises a large amount of fuel storage and relatively low power while second locomotive 920 comprises a large amount of power and relatively low amount of fuel storage. Second locomotive 920 could even contain no additional fuel storage. Such a pairing may be employed for high power and long distance applications. For example, locomotive 920 may comprise one or more turbine power modules 24 having high power while locomotive 910 comprises one or more relatively low horsepower fuel cell power modules 24, rotary power modules 24 spark-ignition power modules 24 or the like. Another advantage of such a pairing is that at low throttle notches, consist 900 can rely primarily on locomotive 910 without having to run turbine power module 24 at low power (and low thermal efficiency, high emissions). Once power is needed (i.e. at higher throttle notches), sufficient power can be achieved through turbine power module 24 of locomotive 920.

By employing different locomotives 910, 920 (or 710, 720 or 810, 820) instead of identical locomotives, fleet utilization can be improved. For example, a fleet of high horsepower locomotives with relatively low fuel storage (or no fuel storage) can be used with tenders for long haul or line-haul service while the same locomotives can be used together with relatively low horsepower but high fuel storage locomotives in local areas or areas such as ports or cities where emissions requirements are more stringent. Powering traction motors under tenders 730 or 830 can further enhance performance characteristics of consists where tenders are employed. However, fuel tenders may be avoided altogether through use of both high power, low storage locomotives in combination with low power, high storage locomotives within a consist.

While many of the locomotives described herein are described as being modular, it is to be understood that this is not mandatory. In particular, locomotives having multiple engines of different types, such as described herein, may be constructed in a non-modular fashion. Further, other features, such as, for example, the control systems, the engine starting systems, the fleet management methods, the methods for running locomotives and consists, and the various configurations of locomotives may all be employed with non-modular locomotives.

While a number of example aspects and embodiments are discussed herein, those of skill in the art will recognize certain modifications, permutations, additions and sub-combinations thereof. For example:
The relative locations and numbers of gaseous fuel internal combustion engine power modules, energy storage modules (i.e. battery modules), fuel cell modules, etc. along the length of the chassis can be varied.
The relative locations, numbers and types of locomotives along the length of a consist or train can be varied.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

In this description and the accompanying drawings certain elements are referred to using the same reference number. The use of the same reference number does not require all components referenced by that number to be the same. For example, in some embodiments having two power modules 24 the two power modules 24 may optionally differ from one another in one or more respects. Also, power modules 24 in different embodiments may be the same or different. Many variations in the construction of power modules 24, fuel modules 22, battery modules 28 etc. may be found in different embodiments. Similarly, different reference numbers applied to similar components permit but do not require the components to differ from one another in respects other than what is described. For example, locomotives 100, 200, 300, 400 and 500 are described. These locomotives differ from one another primarily in the arrangements of modules 20 provided. In other respects the described locomotives may be the same or different from one another.

Reference is made to various controllers, such as controller 80. Such controllers may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained herein and/or combinations of two or more of these. Commercially available engine controllers as known to those of skill in the art may be applied. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, general purpose computers, and the like. For example, one or more data processors in an engine controller system may implement methods as described herein by executing software instructions in a program memory (e.g. a suitable read only memory (ROM) accessible to the processors.

Where a component (e.g. a power module, fuel module, battery module, chassis, controller, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While the invention has been disclosed in its preferred form, the specific embodiments thereof as disclosed herein are not to be considered in a limiting sense, because numerous variations are possible. The subject matter of the invention includes all novel and non-obvious combinations and subcombinations of the various elements, features, functions, and/or properties disclosed herein. No single feature, function, element, or property of the disclosed embodiments is essential to all embodiments. The following claims define certain combinations and subcombinations which are regarded as novel and non-obvious. Other combinations and subcombinations of features, functions, elements, and/or properties may be claimed through amendment of the present claims or presentation of new claims in this or a related application. Such claims also are regarded as included within the subject matter of the present invention irrespective of whether they are broader, narrower, or equal in scope to the original claims. This invention also covers all embodiments and all applications which will be immediately comprehensible to the expert upon reading this application, on the basis of his or her knowledge and, optionally, simple routine tests. In addition, the various embodiments described above can be combined to provide further embodiments.

It is therefore intended that all claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A locomotive comprising:
a first power module, the first power module comprising a first engine optimized to run on a first fuel and a first generator coupled to be driven by the first engine to generate first electrical power;
a second power module, the second power module comprising a second engine optimized to run on a second fuel and a second generator coupled to be driven by the second engine to generate second electrical power;
a first fuel module for storing the first fuel and connected to provide the first fuel to the first power module;
a second fuel module for storing the second fuel and connected to provide the second fuel to the second power module;
an electrical bus connected to the first power module to receive the first electrical power and connected to the second power module to receive the second electrical power and to provide third electrical power to a drive system of the locomotive;
a control system connected to the first power module, the second power module, the first fuel module, the second fuel module and the electrical bus, the control system configured to individually control a first power output level of the first power module and a second power output level of the second power module according to a total power requirement of the drive system of the locomotive.

2. A locomotive according to claim 1 wherein the control system is configured to individually select a power output level of the first power module and a power output level of the second power module based at least in part on a comparison of one or more characteristics of the first fuel to one or more corresponding characteristics of the second fuel.

3. A locomotive according to claim 2 wherein:
the control system is configured to store first pollution emission information comprising first pollution emission values associated with the running the first engine on the first fuel at different first power output levels and second pollution emission information comprising second pollution emission values associated with running the second engine on the second fuel at different second power output values;
the one or more characteristics of the first fuel comprises the first pollution emission values and the corresponding one or more characteristics of the second fuel comprises the second pollution emission values; and
wherein the control system is configured to bias the first power output level and the second power output level to minimize both of the first pollution emission values and the second pollution emission values while providing a cumulative power output from the first and second engines according to the total power requirement of the drive system for the locomotive.

4. A locomotive according to claim 3 wherein the first power module and the second power module each comprise one or more emissions sensors operative to detect one or more emissions of the first power module and the second module; and wherein:
the control system is connected to receive outputs from the one or more emissions sensors of the first power module and the second power module; and
the first pollution emission information and the second pollution emission information are updated in real-time based on the outputs from the one or more emissions sensors of the first power module and the second power module.

5. A locomotive according to claim 2 wherein:
the first fuel module comprises a first fuel level sensor connected to the control system and the second fuel module comprises a second fuel level sensor connected to the control system; and
the one or more characteristics of the first fuel comprises a first fuel level of the first fuel as determined using the first fuel level sensor and the corresponding one or more characteristics of the second fuel comprises a second fuel level of the second fuel as determined using the second fuel sensor;
the first fuel level is higher than the second fuel level; and
the control system is configured to bias the power output level of the first engine to be higher than the power output level of the second engine.

6. A locomotive according to claim 2 wherein:
the first power module comprises a first ambient noise sensor connected to the control system and the second power module comprises a second ambient noise sensor connected to the control system;
the one or more characteristics of the first fuel comprises a first ambient noise emission associated with the running the first engine on the first fuel determined using the first ambient noise sensor and the corresponding one or more characteristics of the second fuel comprises a second ambient noise emission associated with running the second engine on the second fuel determined using the second ambient noise sensor;
a combined ambient noise of the first engine and the second engine is higher than an ambient noise threshold and the first ambient noise emission is lower than the second ambient noise emission; and
the control system is configured to bias a power output level of the first engine to be higher than the power output level of the second engine.

7. A locomotive according to claim 2 wherein:
the control system is configured to store first cost information comprising a first cost associated with running the first engine on the first fuel and second cost information comprising a second cost associated with running the second engine on the second fuel;
the one or more characteristics of the first fuel comprises the first cost information and the corresponding one or more characteristics of the second fuel comprises the second cost information, wherein the first cost information is lower than the second cost information and the control system is configured to bias the power output level of the first engine to be higher than the power output level of the second engine.

8. A locomotive according to claim 7 wherein:
the first cost associated with the running the first engine comprises a cost of the first fuel in the first fuel module, a cost to refill the first fuel module and a cost to operate the first engine per unit of distance; and
the second cost associated with the running the second engine comprises a cost of the second fuel in the second fuel module, a cost to refill the second fuel module and a cost to operate the second engine per unit of distance.

9. A locomotive according to claim 2 wherein the control system is configured to:
monitor and record a first fuel efficiency of the first engine at different first power output levels;
monitor and record a second fuel efficiency of the second engine at different second power output levels;
and wherein the one or more characteristics of the first fuel comprises the first fuel efficiency of the first engine at different first power output levels and the corresponding one or more characteristics of the second fuel comprises the second fuel efficiency of the second engine at different second power output levels and the first power output level and second power output level are biased based on an optimization of the first fuel efficiency of the first engine at different first power output levels and the second fuel efficiency of the second engine at different second power output levels for the total power requirement of the drive system.

10. A locomotive according to claim 2 comprising a navigation system; wherein:
the control system comprises a database of fueling stations for the first fuel and fueling stations for the second fuel;
the one or more characteristics of the first fuel is a distance on a route being traveled by the locomotive to a next fueling station for the first fuel determined using the navigation system and the database of fueling stations for the first fuel and the corresponding one or more characteristics of the second fuel is a distance to a next fueling station for the second fuel determined using the satellite navigation system and the database of fueling stations for the second fuel and the distance to the next fueling station for the first fuel is shorter than the distance to the next fueling station for the second fuel; and
the control system is configured to bias the power output level of the first engine to be higher than the power output level of the second engine to conserve the second fuel.

11. A locomotive according to claim 1 further comprising a battery connected to the electrical bus and configured to store surplus power provided to the electrical bus and wherein the power level of the first power module and the power level of the second power module are lowered after a charge level of the battery is greater than a threshold charge level.

12. A locomotive according to claim 11 wherein the control system is configured to shut off the first power module and the second power module when the battery has a sufficient charge level to maintain a power output equal to or greater than the total power requirement of the drive system for the locomotive for a period sufficient to offset restarting the first power module and the second power module.

13. A locomotive according to claim 1 wherein the control system is configured to bias the power level of the first power module and the power level of the second power module based at least in part on a current operating temperature of the first engine.

14. A locomotive according to claim 13 wherein the first power module comprises a first temperature sensor and the control system is configured to monitor and record a fuel efficiency of the first power module with respect to temperature recorded by the first temperature sensor and wherein control system is configured to bias the first power output based at least upon an optimized operating temperature of the first power module determined based on the fuel efficiency of the first power module with respect to temperature recorded by the first temperature sensor.

15. A locomotive according to claim 1 wherein the first engine has a maximum operating speed greater than 2500 RPM.

16. A locomotive according to claim 1 wherein the first and second engines each have a maximum operating speed greater than 2500 RPM.

17. A locomotive according to claim 1 wherein the first and second fuels are gaseous fuels.

18. A locomotive according to claim 1 further comprising a fuel cell module and wherein the control system is configured to shut off the first power module and the second power module when the total power requirement of the drive system is projected to be less than a maximum available power output of the fuel cell for the locomotive for a period sufficient to offset restarting the first power module and the second power module.

19. A locomotive according to claim 1 wherein:
the first power module and first fuel module are replaceable with an alternative power module and an alternative fuel module by disconnecting one or more attachment points and interconnectors of the first power module and the first fuel module and connecting one or more attachment points and interconnectors of the alternative power module and the alternative fuel module; and
the control system is configured to identify the alternative power module and the alternative fuel module and select the second power output level and an a power output level of the alternative power module based at least in part on one or more characteristics of the second fuel relative to one or more corresponding characteristics of the fuel of the alternative fuel module.

20. A locomotive according to claim 1 further comprising in addition to the first and second power modules and first and second fuel modules:
a diesel engine and a corresponding generator coupled to be driven by the diesel engine to generate fourth electrical power for the electrical bus, the diesel engine having a maximum operating speed below 2500 RPM;
a diesel fuel container for supplying diesel fuel to the diesel engine; and
wherein the control system is configured to have a diesel mode in which a power deficiency of the first power module and second power module is supplied by the diesel engine.

21. A locomotive according to claim 1 wherein the control system is connected to one or more of the first power module, the second power module, the first fuel module, the second fuel module and the electrical bus by a wireless connection.

22. A locomotive according to claim 1 wherein the locomotive comprises a quantum compass connected to the control system and the control system is configured to individually control the first power output level of the first power module and the second power output level of the second power module according to the total power requirement of the drive system of the locomotive based on a location determined by the quantum compass.

23. A locomotive according to claim 1 wherein the locomotive comprises an atomic inertial guidance system connected to the control system and the control system is configured to individually control the first power output level of the first power module and the second power output level of the second power module according to the total power requirement of the drive system of the locomotive based on a location determined by the atomic inertial guidance system.

24. A locomotive comprising:
one or more power modules, each power module comprising one or more high speed engines operable using gaseous fuel at over 2500 RPM and one or more corresponding high speed generators connected to the one or more high speed engines;
one or more fuel modules, each fuel module storing a gaseous fuel and connected to provide the gaseous fuel to one or more of the one or more power modules;
an electrical bus for receiving power from each of the one or more power modules and for delivering power to drive the locomotive; and
a control system configured to coordinate power output levels from each of the one or more power modules to the electrical bus;
wherein the control system is configured to choose a power level of one or more of the power modules of the first subset of power modules and a power level of one or more of the power modules of the second subset of power modules based at least in part on one or more characteristics of the first fuel relative to one or more corresponding characteristics of the second fuel.
